(19) United States
(12) Patent Application Publication
(10) Pub. No.: US 2009/0013255 A1
(43) Pub. Date: Jan. 8, 2009

(54) Method and System for Supporting Graphical User Interfaces

(76) Inventors: Matthew John Yuschik, Cincinnati, OH (US); Cordell Amos Coy, Villa Hills, KY (US); Jayant M. Naik, Mason, OH (US); Karthik Narayanaswami, Cincinnati, OH (US); Ajay Warrier, Cincinnati, OH (US); Michael Louis Nutter, Cincinnati, OH (US)

Correspondence Address: FROST BROWN TODD, LLC, 2200 PNC CENTER, 201 E. FIFTH STREET, CINCINNATI, OH, 45202, US

(21) Appl. No.: 11/966,393

(22) Filed: Dec. 28, 2007

Related U.S. Application Data
(60) Provisional application No. 60/882,906, filed on Dec. 30, 2006.

(51) Int. Cl. G06F 3/16

(52) U.S. Cl. 715/728

(57) ABSTRACT

A user interface for a customer service application can be created and supported such that the user of the customer service application can utilize that application through a variety of modalities. Further, an interface can be supported in such a manner that certain tasks to be performed using that interface are streamlined, which may take place in combination with the enabling of multi-modality interaction.

This application claims priority from the of U.S. Non-provisional application Ser. No. 11/198,934, filed on Aug. 5, 2005, and U.S. provisional application 60/882,906, filed on Dec. 30, 2006, the disclosures of which are hereby incorporated by reference in their entirety.

### BACKGROUND

Automated speech recognition/recognizers (ASR) facilitate natural language processing.

Interactive voice response (IVR) platforms guide callers to data and resources they desire. IVRs may receive caller input in the form of digits from their telephone keypad or may use ASR to recognize the caller's speech. IVR output can be synthesized using text-to-speech or pre-recorded voice.

A media gateway is a telephony system that converts between various telephony protocols (e.g., routers provided by Cisco). Commonly, both analog and digital devices are accepted and a VOIP protocol is used for transmission from the media gateway to the telephony switch. Thus a call originating on a digital device is converted to analog if the receiving party is using an analog phone. The same protocol conversion can happen using session-initiated protocol (SIP) devices.

Real-time transfer protocol (RTP) is a protocol designed for use in carrying time sensitive information on the internet. Voice traffic is the prime user of RTP. RTP stream forking/bridging is a means of duplicating RTP data from one stream onto an entirely separate stream.

Session initiation protocol (SIP) is a W3C standard for establishing a VOIP connection (for example, the Sandcherry VIVO Call Centre or equivalents thereof). It can be used in conjunction with RTP to create a VOIP call. SIP is a peer-to-peer protocol that allows intelligent endpoints to have call control.

Text to speech (TTS) is synthesized or computer generated speech from a text base.

Voice over internet protocol (VOIP) is an alternative to traditional time division multiplexed (TDM) telephony.

Voice extended markup language (VXML or Voice XML) is a W3C standard for directing the activities of interactive voice response systems. In other words, a VXML program describes how a caller's input will be handled, what prompts to speak, and how to recognize the caller's speech. A VXML browser interprets VXML scripts. As an analogy, a web browser renders a page to a user on a PC. A VXML browser renders a page to a user on a telephone (sound-only interface).

A web server and application server run the target/subject application and any related databases/components that the target application may interact with [e.g., environments by Siebel or equivalents thereof].

The design of the telephony architecture and the SIP server components to enable the system are within the knowledge of one of skill in the art.

### SUMMARY

Certain embodiments of this invention are in the field of utilizing streams of voice data to enable and streamline interaction with target applications through their user interfaces. As an illustration of certain objects of the technology described herein, this summary sets forth certain examples of approaches to implementing aspects of the teachings of this application. This summary section should be understood as being an illustration of certain features of the technology described herein, and should not be treated as limiting on the claims included in this application, or on the claims in any related application.

As a first example, it is possible that the disclosure of this application can be used to implement a system comprising one or more customer service applications operable to cause a plurality of windows to be presented on a display. The system might also include an operating system configured to identify a window from the plurality of windows as an “active window.” In the system, use of the customer service applications could be facilitated by a multimodal support application. For example, when the customer service applications are configured to receive input via a mechanical input device, the multimodal support application could also allow interaction with the customer service applications via auditory input. This could take place by the multimodal support application being configured to perform acts such as: receiving an auditory input stream and an identification of the active window; identifying a context based on the identification of the active window; identifying a keyword from the auditory input stream; associating the keyword with the context; and, based on the keyword and the context, issuing one or more commands manipulating (at least) one of the customer service applications.

For the sake of clarity, the terms used above in describing the “customer service application” should be understood as follows. The term “application” as used above should be understood to refer to a program designed to perform a specific function. Examples of “applications” include Microsoft Word (a word processing application), World of Warcraft (a gaming application) and Mozilla Firefox (an internet browsing application). Accordingly, a “customer service application” should be understood to refer to an “application” which can be used either to provide, or to facilitate the provision of, service to a customer. The above description also noted that the customer service applications might be operable to cause a plurality of “windows” to be presented on a display, and that the customer service applications might be configured to receive input via a “mechanical input device.” In that context, the term “window,” should be understood to refer to a viewing area on a computer display screen in a system that allows multiple viewing areas as part of a graphical user interface. Also, a “mechanical input device” should be understood to refer to a device which provides information based on a physical stimulus. A concrete example of how a “customer service application” could be configured to receive input via a “mechanical input device” is if the “customer service application” displayed a window which includes a field where the user could enter input with a keyboard (physical stimulus of pressing keys) or make a selection using a mouse (physical stimulus of clicking buttons) or a stylus (physical stimulus of positioning the tool), or on a touchscreen (physical stimulus of contact with screen).

Turning now to the next component of the system described above, the “operating system” should be understood to refer to a program which, when loaded into a computer, manages the operation of the other programs (applications) in a computer. Examples of “operating systems” include Windows, distributed by Microsoft, and Linux, distributed under the General Public License, and supported by companies such as IBM. When an “operating system” is described as being configured to identify an “active window” it should be understood to mean that the operating system comprises instructions which, when executed (for example, by a computer), recognize a particular window as being the window utilized at that time as a focus of interaction with the user. As an example of such identification, in the windows operating system, when multiple windows are displayed, the window which is currently being used (generally displayed in the foreground) would be the “active window” (while other windows would be “non-active”).

Turning to the final component in the above description, a “multimodal support application” should then be understood to refer to an application which supports the operation of another application by enabling the application being supported to interact with one or more modalities processed through the “multimodal support application.” When a “multimodal support application” is described as configured to receive an “auditory input stream,” it should be understood to mean that the “multimodal support application” is capable of receiving a flow of sound information, such as the data collected by a microphone. When a “multimodal support application” is described as being configured to identify a “context” based on an identification of an “active window” it should be understood that the “multimodal support application” can determine a set of relevant information based on the window which is the focus of interaction with the user. As an example, a “multimodal support application” which is configured to select a set of grammars to use in interpreting an auditory input stream based on the window which was active when the auditory input stream was received would be one which identifies a “context” (relevant grammars) based on identification of the “active window.” Of course, such a system might also use other grammars (e.g., universal grammars which recognize terms such as “help” or “home page”) in addition to those which are selected based on identification of the “active window.” An identification of a “keyword” in an “auditory input stream” should be understood to refer to an identification of an utterance (e.g., a word or phrase) which triggers the performance of one or more actions (e.g., manipulating a customer service application in some manner). When a “multimodal support application” is described as being configured to “associate a keyword and a context,” it should be understood to mean that the “multimodal support application” is configured to establish a connection or relationship between the “keyword” and the “context.” For example, a “multimodal support application” which comprises instructions to connect the utterance “BILL” with a task being completed (e.g., a “bill inquiry”) or with information which has been provided in an interaction (e.g., that the caller's name is Bill) would be one which is configured to “associate a keyword (e.g., “BILL”) and a context (e.g., information provided, or task being performed as could be demonstrated by a currently active window or field within a window).” Finally, when a “multimodal support application” is described as being configured to “issue one or more commands” based on the keyword and the context, with the commands “manipulating” (at least) one of the customer service applications, it should be understood to mean that the “multimodal support application” sends one or more signals indicating actions to be taken (commands) and that those actions have the effect of operating, controlling, or interacting with (manipulating) the (at least one) customer service application.

Continuing with the description of potential approaches to implementing some aspects of the technology described herein, certain refinements on the system described above could also be implemented. For example, in some systems where a multimodal support application issues commands which manipulate at least one customer service application, that manipulation could take the form of launching a customer service application from the plurality of customer service applications which make up the system. The manipulation might be performed by using an application programming interface exposed by the customer service application being manipulated. In some cases, one or more of the customer service applications included in the system might be self care applications. Also, the multimodal support application from the system description set forth above might be implemented to be resident on a workstation operated by a customer service representative.

For the purpose of clarity, certain terms used in the above description of potential refinements should be understood as having particular meanings. For example, “launching” a customer service application should be understood to refer to initiating the execution of that application. When “manipulation” is described as being performed by using an “application programming interface function exposed by” a customer service application, it should be understood to mean that the manipulation takes place by calling a named procedure that performs a distinct service (function) which is made available to other programs (exposed by) by a source code interface which can be used to provide requests (application programming interface) to the customer service application. When a “multimodal support application” is described as “resident” on a “workstation operated by a customer service representative,” it should be understood to mean that the data which makes up the multimodal support application is physically stored (resident) on or in a computer designed to be used by a single, locally situated user (workstation), and that the single, locally situated user is an agent who is employed to provide service to a customer (customer service representative). As an example, if a multimodal support application was stored in the memory (e.g., hard drive, random access memory) of a personal computer (PC) used by a call center agent, then that customer service application could be described as being “resident on a workstation operated by a customer service representative.” Finally, in the above description of refinements, when a customer service application is described as a “self care application” it should be understood to mean that the application is one which which instructs a user of a product or service how to perform acts which enable or facilitate the user's interaction with the product or service.

A further type of refinement on the system described above is one where the system is deployed across a plurality of components comprising a client computer, an application server, and a voice assist server. In such a system, the operating system might be resident on the client computer, the one or more customer service applications might be resident on the application server, an automatic speech recognizer might be resident on the voice assist server, and the multimodal support application could be configured to use multiple portions: a local portion resident on the client computer, and a remote portion resident on the voice assist server. In such a case, the multimedia support application could be configured to use the local portion resident on the client computer to mediate communication of the auditory input stream to the voice assist server, and the remote portion resident on the voice assist server might be used to identify a keyword in the auditory input stream. As a further refinement, in a case where the client computer is a customer service representative workstation, the multimodal support application might be configured to communicate directly with the customer service applications resident on the application server. Also, in some cases, mediating communication of the auditory input stream might be performed by the local portion by monitoring operation of a “push to talk tool,” and transferring real time protocol information for the voice assist server to a session initiation protocol server.

For the sake of clarity, certain terms in the above description should be understood as having particular meanings. The term “automatic speech recognizer” should be understood to refer to software that allows a computer to identify the words that a person speaks. The term “computer” should be understood to refer to a device or group of devices which is capable of performing one or more logical and/or physical operations on data to produce a result. The term “client” is understood in the art to refer to an entity which makes requests for services to be performed by some other entity. Often (though not necessarily), the “client” is an application program (or computer running such a program) which sends request over a network for information or instructions that is received by another application being executed on a remote computer (generally referred to as a “server”). Thus, to say that the customer service applications are “resident on an application server” means that code for the service applications is stored on a computer which can respond to requests (server) and is used to execute applications.

Another concept utilized in the system described above is that an application can use multiple portions resident on different components to accomplish its function. As described above, this type of organization is used by the multimodal support application which uses a local portion and a remote portion. For clarity, the term “portion” should be understood to refer to a piece of a larger entity (e.g., an application). The modifiers “local” and “remote” which are associated with the word “portion” in the description above are intended to indicate physical proximity of that portion to a particular reference point (in the above description, the client computer). Accordingly the “local portion” being described as mediating communication of the auditory input stream to the voice assist server means that the piece of the larger application which is resident on the client computer controls (mediates) the provision of the auditory input stream to the voice assist server. When that mediation is described as taking place by “monitoring” the operation of a “push to talk tool,” it should be understood to mean that the local portion observes, measures or detects (monitors) the use of an aspect of a user interface which is provided to allow an operator to indicate that information should (or should not) be transferred (push to talk tool). Finally, the “real time protocol information” described as potentially transferred by the local portion, should be understood to refer to information which allows a real time protocol connection to be used or created, while a “session initiation protocol server” (identified as the potential recipient of the real time protocol information) should be understood to refer to a server which allows an interaction utilizing the session initiation protocol to proceed.

Turning now to the operation of the remote portion described above, when the remote portion of the multimodal support application is configured to communicate “directly” with the customer service applications on the application server, it should be understood to mean that the remote portion is able to send information (communicate) to the applications resident on the application server without requiring processing of that information to be performed on any other computer (e.g., a client computer, such as a customer service agent workstation). Of course, it should be understood that such “direct” communication does not preclude the use of network servers, routers, and other pass through devices which simply have the function of transferring information from one point to another.

Of course, the above system (and the described refinements thereto) should not be understood as being the only potential implementations of the technology described in this application. For example, the techniques described herein could be used to implement a system which comprises one or more customer service applications, a graphic user interface, a plurality of grammars, and an automatic speech recognizer. In such a system, the customer service application might be configured to perform one or more tasks during a customer service interaction (a series of communications between a customer and one or more other entities). The graphic user interface might comprise a plurality of windows (one of which is an active window), and be operable to enable a user to provide a set of data necessary for completion of a task from the tasks which could be performed by the one or more customer service applications. The grammars from the plurality of grammars might correspond with one or more of the windows from the plurality of windows. The automatic speech recognizer might be configured to provide an interpretation for an auditory input using a set of active grammars from the set of grammars. In such a system, there might also be a set of computer executable instructions stored on a computer readable medium. That set of instructions might be operable to configure a computer to perform a set of tasks such as allowing the user to provide an auditory input to the automatic speech recognizer, identifying the set of active grammars such that the set of active grammars consists of those grammars which correspond to the active window, and, based on one or more keywords identified by the automatic speech recognizer using the set of active grammars, providing a set of commands to a customer service application.

For the sake of clarity, the following meanings should be used to understand the above description. A “graphic user interface” should be understood to refer to a visual interface which does not consist strictly of text. Also, “data” should be understood to refer to information which is represented in a form which is capable of being processed, stored and/or transmitted. Thus, the statement that a “graphic user interface” is operable to enable a user to provide a set of “data” necessary for completion of a task, it should be understood to mean that a visual interface which does not consist strictly of text (e.g., a window such as might be provided by an internet browser) includes features which allow (is operable to) a user to provide information in a form which can be processed, stored and/or transmitted (data), the provision of which is a precondition (necessary) for completion of a task. Another term used above which should be understood as having a particular meaning is a “grammar,” which should be understood to refer to a data structure which specifies a set of utterances that a user may speak to perform an action or supply information. When a “grammar” is described as “corresponding” with a window, it should be understood to mean that the “grammar” is matched with and has an association with the window. For example, there might be a master list which includes an enumeration of all windows which could be displayed by the graphic user interface, and a key which indicates which grammars “correspond” to the particular windows. When a “grammar” is described as being used to “provide an interpretation” for an auditory input, it should be understood to mean that the “grammar” is used to identify the semantic payload (interpret) the auditory input. Finally, the phrases “computer readable medium,” and “computer executable instructions,” which are used in the above description, should be understood as follows. The phrase “computer readable medium” should be understood to include any object, substance, or combination of objects or substances, capable of storing data or instructions in a form in which they can be retrieved and/or processed by a device. A “computer readable medium” should not be limited to any particular type or organization, and should be understood to include distributed and decentralized systems however they are physically or logically disposed, as well as storage objects of systems which are located in a defined and/or circumscribed physical and/or logical space. The phrase “computer executable instructions” should be understood to refer to refers to data which can be used to specify physical or logical operations which can be performed by a computer.

As a refinement on a system of the type described above, in some cases it is possible that the correspondence between windows and grammars might be based at least in part on the contents of the windows. For example, in some cases the windows from the plurality of windows might comprise fields. For each of the fields, the grammars from the plurality of grammars could be particularly configured to recognize input for that field. In such a case, the set of active grammars which corresponds to the active window (and could be used to provide an interpretation of an auditory input received while that window was active) could comprise one or more of the grammars which are particularly configured to recognize input for the one or more fields from the active window.

For the sake of clarity, in this context, a “field” should be understood to refer to an element in a user interface into which information can be entered (e.g., a text box, radio button, check box, or other types of field known to those of ordinary skill in the art). Additionally, when something is described as being “particularly configured” for some purpose, it should be understood to mean that the thing is specifically adapted to achieve the identified purpose for which it is “particularly configured.” Thus, an example of a grammar which is “particularly configured” to recognize input for a “field” would be a grammar which includes a vocabulary of words which are valid inputs for the field the grammar is “particularly configured” to recognize inputs for. With that in mind, an example of a system in which “active grammars” comprise the grammars which are particularly configured to recognize input for fields from the active window would be a system where the active window comprises at least one field, and that the “active grammars” (i.e., those grammars that are used to interpret input) is a set of grammars which includes the grammars that recognize the input for the fields in the active window (though other grammars, such as a universal grammar which recognizes commands such as “cancel”, may also be included).

As yet a further example of a type of system which could be implemented based on this disclosure, consider a system which is made up of one or more customer service applications configured to receive input via a mechanical input device; a voicepad configured to contextually store inputs received during a customer service interaction; and a multimodal support application configured to transfer inputs stored in the voicepad to the customer service applications, and to send commands to the customer service applications to complete a task once the inputs necessary for the task have been transferred to the customer service application.

To help clarify the description above, certain terms used in that description should be understood as having particular meanings. A “task,” such as might be performed by a customer service application, should be understood to refer to a definite action or series of steps to be performed (e.g., a workflow in a software application or interaction). A “voicepad,” such as might be configured to contextually store a plurality of inputs, should be understood to refer to a portion of a system for supporting a multimodal user interface which comprises dedicated computer memory for storing information and may also include computer executable instructions for controlling how information is stored in the computer memory, and/or for augmenting and utilizing that stored information. When a “voicepad” is referred to as “contextually storing” some information, it should be understood to mean that the voicepad retains (stores) the information along with other information indicated as relevant based on the circumstances during which the storage takes place (e.g., what window is active when the information is stored). When inputs are described as being “transferred” from the voicepad to the customer service applications, it should be understood to mean that the inputs are conveyed from their original storage in the voicepad to the customer service applications (e.g., by copying the inputs from a location in RAM allocated to the voicepad into location in RAM allocated to the customer service applications).

As a refinement to a system of the type described above, in some cases such a system could be implemented so that the multimodal support application is able to automatically interact with multiple windows. Thus, if the customer service applications are configured to cause a plurality of windows to be presented on a display, the multimodal support application might be configured to automatically insert an input stored in the voicepad into a first field from a first window, and into a second field from a second (different) window. In such a case, the windows might even be generated by two different applications, that is, the first window might be an application window for (be a window which is generated by) a first customer service application, while the second window could be an application window for a second (different) customer service application. In some cases, there might be particular features of the system designed to support such automatic data insertion. For instance, there might be software perceptible markers used to identify the fields where data is to be inserted as being semantically equivalent. Also, in some cases, when a voicepad contextually stores inputs, it might appending a tag to the inputs. Then, the automatic insertion of an input into the fields might be based on a correspondence between the tag on the input and the software perceptible markers on the fields where it is to be inserted. As a further variation, in some cases causing a plurality of windows to be presented on a display might comprise causing the plurality of windows to be presented on the display in sequence (i.e., an ordered succession), wherein the first window is presented on the display at a first time, and the second window is presented on the display at a second time, and wherein the second time occurs after the first time.

To ensure the clarity of the above description, certain terms used in that description should be understood as having particular meanings. An “input” should be understood as some information or data which is provided for processing or storage. The term “append” should be understood as referring to the act of attaching something to something else. Thus, to “append a tag” to an “input” should be understood to refer to the act of attaching a marker (tag) to a piece of information or data, such as by appending a suffix to a string representing the input, adding a value to a data structure containing the input, or by using some other technique. A “software perceptible marker” such as described above as corresponding to a tag should be understood to be an indication that can be detected and acted upon using software. One popular marker type is metadata, though other there are other types of software perceptible markers, such as labels, and variable names. The “software perceptible marker” might be used to establish “semantic equivalence” of two fields, with “semantic equivalence” meaning that the fields' function, or significance. An example of fields which are “semantically equivalent” would be two fields, in two different windows, where a user is expected to enter his or her first name. Finally, “automatically inserting” an input into multiple fields should be understood to refer to inserting the input through the function of a machine (e.g., a computer configured with appropriate software) without requiring human intervention or direction.

Another refinement which could be made is that assumptions might be made which could facilitate use of a customer service application. This could take place, for example, when a multimodal support application is configured to send commands to a customer service application based on assumptions having a high confidence value. In such a case, the assumption could comprise a value for data transferred, an identification of a sequence of events desired by a user of the customer service application, or some other information. In this context, an “assumption” should be understood as a proposition about the state of the world which is based on incomplete information (i.e., it is not specifically provided, nor is it certain based on known information). Assumptions having a “high confidence” are those assumptions where, while not certain based on known information, have a likelihood which is deemed sufficiently great that they can be used. Examples of an assumption comprising a value for data to be transferred include an assumption as to a recognition result, or a default (rather than explicitly specified) value for information about a user. An example of a situation where an assumption might be made regarding a sequence of events desired by a user is where a user's pattern of activity is consistent with a particular goal, in which case the system might make an assumption that the user wishes to perform the sequence of events that would achieve that goal.

Yet a further refinement would be to configure a multimodal support application to monitor whether inputs stored in a voicepad are required by a customer service application to complete a task. Where such monitoring takes place, transferring inputs from the voicepad to the customer service application could be triggered by the customer service applications requiring the stored inputs to complete the task. Such a system could be used to, for example, collect inputs in the voicepad before they are needed (required), and transfer those inputs only when the task is to be completed.

Additionally, in some cases, a system could be implemented which comprises an Agent Voice Assist System (AVA) a label that refers to embodiments, in whole or in part, of the invention, including an agent voice assistance application and a voicepad application which are disposed between an interactive voice response system (IVR) and a target application.

The MMApplet is the Multi-Modal Applet which patches a recognizer to an agent phone, the corresponding JavaScript code that activates the appropriate recognition grammars and the control software that synchronizes the VXML and GUI applications.

An embodiment of an agent voice assistance application/invention may comprise a computer system/method for supporting user interfaces of at least one target application though the use of a voicepad application. The agent voice assistance application comprises computer-executable instructions configured to monitor said voicepad for information needed by said at least one target application to complete a task. The agent voice assistance application further comprises computer-executable instructions to populate said at least one target application with said information stored on said voicepad.

In another embodiment, there is a computerized system for streamlining navigation of a user interface wherein said agent voice assistance application further comprises computer-executable instructions to execute a task on said at least one target application once a pre-determined amount of information has been transferred to said target application.

In another embodiment, there is a computerized system for streamlining a user interface wherein said agent voice assistance application further comprises computer-executable instructions to populate a field occurring in a plurality of screens associated with said at least one target application with said information stored on said voicepad.

In another embodiment, there is a computerized system for streamlining a user interface wherein said agent voice assistance application further comprises computer-executable instructions to populate a field appearing in a plurality of screens associated with two or more target applications with said information stored on said voicepad.

In another embodiment, there is a computerized system for streamlining a user interface wherein said agent voice assistance application further recognizes a specific keyword from said set of inputs to start a sequence of events, associated with a transaction, based on a set of assumptions that have a high confidence value.

In another embodiment, there is a computerized system for streamlining a user interface wherein said voicepad stores input in advance of said at least one target application needing said input to complete a task and said agent voice assistance application is configured to retrieve said stored input at such time as said input is required.

In another embodiment, there is a computerized system for streamlining a Multimodal user interface, of which speech is a component, wherein said voicepad stores input in advance of at least one target application, in which a Graphical User Interface (GUI) component expects input to complete a task, and said voice assistance application is configured to retrieve stored input at such time as said input is required and place it in an appropriate location of the GUI.

### BRIEF DESCRIPTION OF THE DRAWINGS

The drawings and detailed description which follow are intended to be merely illustrative and are not intended to limit the scope of the invention as set forth in the appended claims.

FIG. 1 illustrates an embodiment of the AVA components within an overall architectural diagram.

FIG. 2 is an embodiment of an AVA Telephony Architecture.

FIG. 3 illustrates how AVA calls are routed through the ACD to the agent in an embodiment.

FIG. 4 illustrates how an applet controls the VUI/GUI to coordinate agent actions in both voice and web applications.

FIG. 5 illustrates a system diagram for an exemplary implementation.

FIG. 6 illustrates a sample integration of AVA with a target application in an embodiment.

FIGS. 7A-1 and 7A-2 depict a walkthrough of a process employed by an embodiment of the invention.

FIGS. 7B-1 and 7B2 depict a walkthrough of a step-by-step version of the process depicted in FIGS. 7A-1 and 7A-2.

FIGS. 8-1 and 8-2 depict a sample set of specialized transaction phrases combined in state-specific vocabularies.

### DETAILED DESCRIPTION

The following description should not be used to limit the scope of the present invention. Other examples, features, aspects, embodiments, and advantages of the invention will become apparent to those skilled in the art from the following description, which includes by way of illustration, at least one of the best modes contemplated for carrying out the invention. As will be realized, the invention is capable of other different and obvious aspects, all without departing from the invention. Accordingly, the drawings and descriptions should be regarded as illustrative in nature and not restrictive. It should therefore be understood that the inventors contemplate a variety of embodiments that are not explicitly disclosed herein.

Call Center Architecture

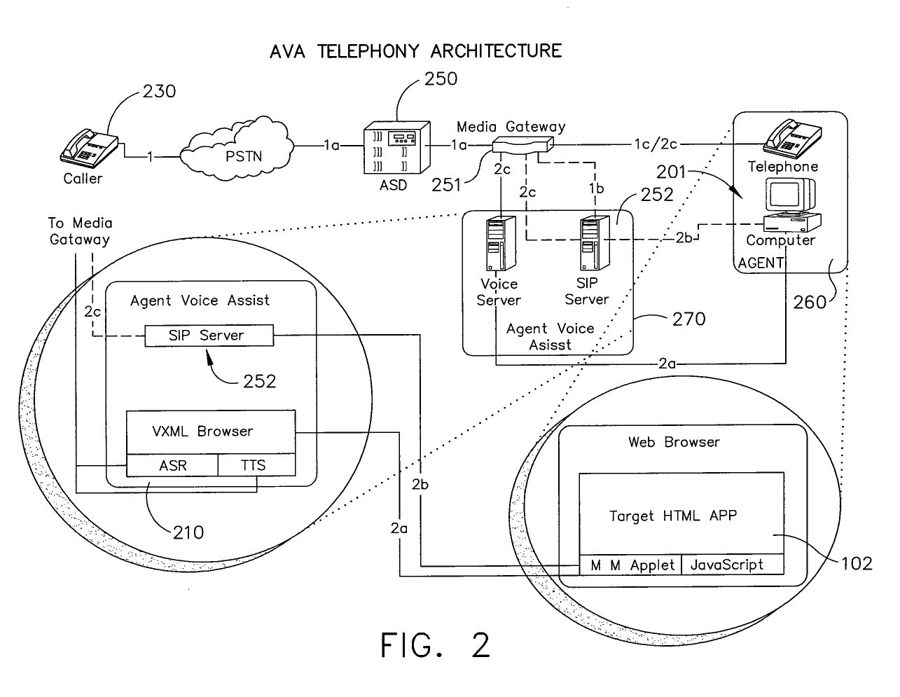

FIG. 2 depicts a voice-enabled call center using AVA. In one embodiment, a CSR may have a workstation [201] that includes a user interface (UI) to a customer relationship management system, which may allow the CSR to undertake tasks on behalf of the caller (230), such as making a payment, placing an order, reporting a dispute, or requesting a change of service, etc. This system comprises existing call center components augmented with a voice recognition system which may include components such as an automatic speech recognizer (ASR) [210]. Various embodiments described herein may be used to assist CSRs in communicating with and providing various customer service functions for customers via telephony systems. A telephone conversation may be conducted using a variety of technologies including, but not limited to, direct circuit or using Voice over IP (VOIP) telephony. Similar features may be implemented through an analog or digital phone interface card within a PC and an associated PC handset/headset with the voice routed through the PC, or other configurations. As will be described below, various embodiments described herein include the use of vocal utterances by CSRs, callers [230], and/or other parties in a variety of ways instead of or in cooperation with other input modalities (keyboard/mouse/stylus/touch screen/etc.). Embodiments also include tools and interfaces for effecting such uses including but not limited to Natural Language Understanding (NLU), and/or Automated Speech Recognition. The voice recognition system uses a SIP/VOIP based telephony bridging feature to direct the agent's voice to the automated speech recognizer (ASR) [210] when the agent signals to use voice commands rather than keyboard or mouse directives. Embodiments are depicted in a call center environment; however, embodiments may be used in a variety of other industries and environments.

Agent Voice Assist (AVA)

AVA (Agent Voice Assist) is a multimodal user interface that enables an agent [260] to use spoken utterances through a voice user interface (VUI) to enter data or navigate through an application that is rendered using a Graphical User Interface (GUI). AVA can be “wrapped around” the GUI application without making substantive changes to the application code via a web interface. AVA may also be loosely integrated with the target GUI by using API functions which enable AVA to directly access features of the application. AVA may also be tightly integrated by having AVA actions built as equivalent to GUI actions (e.g., input via other means such as keyboard or mouse). Hence, AVA permits voice and graphics to be used for the same task, depending on agent preference.

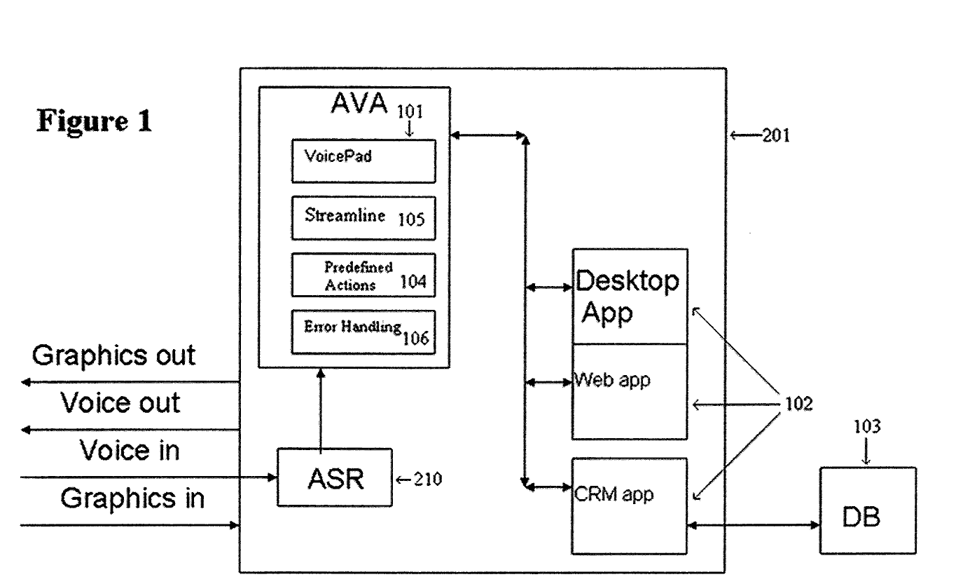

An exemplary system diagram for a system using an AVA type interface is shown in FIG. 1. As shown, AVA may optionally run entirely on a CSR's desktop PC [201]. Of course, various features may run on various components of a system, including networked components, and are certainly not limited to running only on a CSR's desktop PC [201]. AVA may thus be deployed at a desktop level, at the network level, or elsewhere, including combinations thereof.

The agent voice assist application may be configured to accept input via a number of modalities (voice, keyboard, mouse, touchpad, stylus, data pulls from pre-existing sources/databases, voicepad [101], etc.). The agent voice assist application may be configured to provide output through a number of modalities (display screen, highlighted characters or fields on the screen, recorded voice, synthetic voice, auditory tones or sounds, dynamic activation of buttons, etc.) These inputs and outputs are integrated together through a MultiModal User Interface so that any modality can be used for input or output, yet the mode of input or output is transparent to one or more of the applications [102].

To the extent that only a portion of the fields in a form/database/etc. are voice-enabled such fields may be visually distinguished, in the GUI, from the other fields, (e.g., highlighting). In some situations, a given piece of information could be inserted into a variety of fields in a form/database/etc., in such situations; AVA may prompt the CSR to clarify which field to enter the information. Alternatively, the CSR may select the proper field by using his or her voice or by interaction with a graphical user interface before uttering the information or otherwise pre-designate the field. In another embodiment, AVA may consider the context of the utterance to choose the field the information should be entered into. Still other ways may be used to effect data entry, such as AVA gathering information directly from the speech of the customer, rather than functioning based on information uttered by the CSR. In any case, AVA may use the input directly or it may store the input into a voicepad [101]. If voice is converted to text and stored in the voicepad [101], embodiments of the invention may copy/cut/manipulate any or all of the text from the voicepad [101] for use in any other application [102] (e.g., to enter vocally uttered data into a database [103] or appropriate fields in a form, etc.).

As shown in FIG. 1, a system may further comprise a framework in which client applications [102] may be launched or hosted in conjunction with AVA. AVA may be designed to interface with one or more of those applications (including multiple applications simultaneously). AVA may be used with a variety of input devices and output devices. The framework may host a variety of client applications [102], which may be displayed on a tool bar within the UI. The framework may also interface AVA with one or more of the applications [102], such that AVA may be used to perform predefined actions [104] (e.g., data entry and/or command entry) for such applications [102], including multiple applications [102] simultaneously.

Speech Recognition

The term “recognizer” shall be read generically to include any tool that is configured to monitor and/or analyze the substance of speech, such as in voice form, text form, numerical form or any other form. The type of recognizer used shall depend on the type of speech recognition which is suitable to a given target application or situation. Recognizers may include listeners (associated with natural language processing), speaker dependent recognition, speaker independent recognition, isolated keyword recognition, customized vocabulary detectors, voice activated dialing detectors, automated speech recognition tools and more. Speech-recognition functionality may be integrated via an engine (e.g., Nuance, IBM or Microsoft, or any other source or engine).

In the VOIP/SIP environment, the caller and agent channels may be mixed or also separated so that the recognizer may be set up to work with input from the agent, the caller, or both. In another alternative, a single recognizer may be switched between the caller and the CSR based on voice energy detection. If a single recognizer is used, buffering may be utilized so that if both the CSR and the caller speak at the same time, one of the speech streams could be delayed or ignored. In yet another embodiment, a CSR channel and a caller channel each have a respective dedicated Recognizer.

With a Recognizer tool, AVA may be configured to associate at least one keyword with at least one business transaction, command, or other realm of information. For instance, the recognizer tool may monitor and analyze communications received through the CSR channel and/or the caller channel, detect the occurrence of the keyword, and thereby recognize the business transaction. AVA may then use the analysis by the recognizer [210] to invoke one or more actions [104] to perform the business transaction, automatically or at the CSR's request. Transactions may include navigating and completing forms, setting the context for future utterances, copying information from certain fields, etc. The Recognizer tool may constantly run in the background, may start and stop running in response to user input or another event, or may run pursuant to a variety of other circumstances. Other variations of a Recognizer tool will be apparent to those of ordinary skill in the art.

It will be appreciated that keywords, such as those to which a Recognizer tool is responsive, may come in a variety of forms. For instance, a keyword may be a single word such as one that may be naturally uttered during a typical conversation between a CSR and a caller. Such keywords may permit the CSR to perform tasks during the normal course of conversation with a caller. In other words, a CSR will not necessarily need to utter words that are outside the normal conversational language that he/she would typically use with a caller, thereby making the entry and analysis of such words appear to be seamless. A keyword may alternatively be a codeword not typically uttered during such conversations. A keyword may also comprise a phrase rather than a single word.

In yet another embodiment, a keyword may comprise a single word, yet have a pre-defined context sensitivity. For instance, it may be desirable that the utterance of a certain keyword trigger an event when it is uttered in one or more contexts, yet not trigger an event (or trigger a different event) when it is uttered in other contexts. The Recognizer tool may be configured to recognize the context in which the word is uttered to determine whether or not to trigger the event. This embodiment may differ from those where a phrase constitutes a keyword in that the utterance of the single keyword may itself trigger an additional workflow or process to analyze the language surrounding the potential keyword to determine its context. Such context sensitivity may also be useful where a keyword has various homophones, semantically equivalent expressions or in other situations. In addition, the Recognizer tool may have a dynamic vocabulary and/or grammar of keywords and context recognition information. Grammar includes various ways a keyword or phrase can be spoken. With a dynamic vocabulary, the Recognizer may also monitor and analyze information and/or commands that are input manually (e.g., via a keyboard) by a CSR and compare the same to what the Recognizer hears, such that the Recognizer may continue to establish keywords, context recognition, events, and rules.

A recognizer may be configured to recognize speech commands for performing one of the predefined actions [104] for the CSR. For instance, the speech commands may be application specific or generic commands, such as copy commands, cut commands, paste commands, commands to open or close applications [102], commands to play pre-recorded greetings, commands to enter a telephone number, commands to enter standardized note-taking phrases into a notes field, commands to initiate unconstrained dictation of notes, commands to play standard phrases, additional comments and combinations thereof.

AVA may operate in two modes (either separately or in combination): Passive Keyword mode and Directed Command mode.

Passive Keyword Mode

In the Passive Keyword mode, AVA may use the Recognizer to listen for certain keywords that prompt pre-defined actions [104] in the appropriate application [102]. The Passive Keyword mode may thus include indefinite monitoring of speech uttered by the CSR, the caller, a supervisor, or someone else. Of course, the timing of when such monitoring starts and stops may be subject to the control of the CSR, an application [102], or some other source. It will be appreciated that the vocabulary known by a recognizer may vary depending upon the state/condition/screen the recognizer is in, as well as the ways in which it monitors for the utterance of such vocabulary and the ways in which it responds to the utterance of such vocabulary.

An example of Passive Keyword mode use, in customer service operations, may be implemented during inbound calls concerning bill inquiries. For instance, a “Bill Inquiry” business event may be configured in AVA. In particular, the Recognizer may be configured to listen for certain keywords from the CSR channel, such as “bill,” to indicate that the customer is requesting a “Bill Inquiry.” To the extent that the Recognizer has phrase-based vocabulary and/or context sensitivity, the Recognizer may be able to distinguish between the utterance of “bill” as a request for a bill inquiry versus the utterance of “Bill” as the CSR repeating the name of a caller named Bill. In addition, the configuration may identify the information to perform the event. For the “Bill Inquiry” event, for instance, this may be the customer's mobile phone number and the desired month of the inquiry.

When the “Bill Inquiry” business event keywords are detected in a Passive Keyword operation, information status item/icon labeled, “Bill Inquiry in progress” may be displayed on the CSR's desktop. Of course, any other indication may be used, or none at all. Behind the scenes, the application may begin listening for the additional pieces of information (e.g., the mobile number and month) that would enable a jump into the appropriate billing system to perform the requested bill inquiry.

Once the Recognizer “hears” the customer's mobile number and month (which it may automatically populate in the voicepad [101] screen) from the CSR channel via the CSR/customer interaction, it will recognize that it has the information. AVA may then use its configuration data to streamline navigation by jumping into the appropriate billing application [102], populating the necessary field from the voicepad [101], and pulling up the customer bill.

The CSR may switch from “Passive Keyword” mode to “Directed Command” mode with a key stroke or any other form of input. For example, a function key may be defined as a “hot key” to move from one mode to the other. The “Passive Keyword” and “Directed Command” modes may also co-exist.

Directed Command Mode

In the “Directed Command” mode, the CSR will proactively command the desired step, sequence, script, etc.

The CSR may, for instance, speak a directed command such as “copy Address to Application A's Address” and AVA would then copy the contents of its “Address” field, in the voicepad, into the target system's (e.g., Application A) Address field. Likewise, the CSR may direct AVA to copy notes in voicepad [101] to a comment field in the target application [102].

In another embodiment, push operations (i.e., operations performed by the computer without user intervention) may be scripted and pre-configured into the application [102]. A CSR could invoke a single directed command of “Wrap up Application A,” and these pre-configured scripts could navigate any relevant windows in several desktop applications to perform wrap-up operations, including the transfer of any information stored in the voicepad [101] to any applications [102] associated with AVA. Such wrap up operations may be facilitated through a comprehensive set up of voicepad [101] fields, and correlation between the fields of the voicepad [101] and the fields of the other desktop applications [102].

“Directed Command” mode could also be used to enable the CSR to easily switch between applications [102]. AVA could be configured to enable the CSR to call up a specific application [102] via a “voice tag” for the application [102]. For instance, the word, “Application A” could be a voice tag that is interpreted to mean that the CSR would like to bring up Application A to perform work. In one embodiment, such voice tags are pre-defined and uniform for various CSRs. In another embodiment, the voice tags are defined by the CSR, such that each CSR can create his/her own list of voice tags for switching between applications [102] or performing other tasks (e.g., execution of pre-defined actions [104]).

Voicepad

In another embodiment, a system may include a voicepad component [101], or a substantially hands free system that is prompted by the CSR's voice communications. The ASR [210] used in conjunction with AVA filters out non-essential communications (e.g., hmms, umms, ahs, etc.). For instance, the CSR may speak into a microphone or headset to transcribe information to a voicepad [101] instead of taking manual notes. In another embodiment, a voicepad [101] provides a window comprising text representing a transcription of a conversation between a caller and a CSR. Text representing speech may be graphically displayed contemporaneously with or after a phone call, and/or may be saved permanently (e.g., in an archive) or temporarily (e.g., in a cache).

In one embodiment, the CSR may speak into a CSR channel by using a microphone that is separate from the device through which the CSR speaks to the caller. Alternatively, the speaker channel on a CSR's headset may be separated from the caller channel, such that the speaker channel on the CSR's headset may serve as the CSR channel. While the present example includes an ASR [210] configured to receive input via a CSR channel, it will be appreciated that the ASR [210] (and, ultimately the voicepad [101]) may additionally or alternatively be configured to receive input via a caller channel or any other channel.

It will be appreciated that a voicepad [101] may include or provide the storage of various data collected during the call. In one embodiment, the voicepad [101] itself comprises a data store. In another embodiment, data stored on or by the voicepad [101] is written to a data store. For instance, the data used for a particular business event and the event itself may be kept in a persistent data store to allow data to be further searched, analyzed, and manipulated. Text, audio, or combinations thereof may be stored in a centralized relational database, in a free text database, or in any other type of database or format. The information in a database may be used to automatically generate a reference, such as a frequently asked questions list.

A data store may be located at a data enterprise or locally on a PC. A data store may enable data to be duplicated between applications [102] without creating an additional application [102] or requiring re-entry by the customer or CSR. In other words, data may be mapped from one application [102] to another through the AVA application.

The agent voice assist application interfaces with the voicepad [101]. To the extent that the voicepad [101] is configured to receive input via a plurality of channels (e.g., caller channel, agent channel, supervisor channel, etc.), it will be appreciated that such receptivity may be allocated among the channels based on a variety of factors (e.g., the type of information sought, the application currently being used, a prior utterance, etc.). For instance, the agent voice assistance application can configure the voicepad [101]/ASR [210] to accept input via a designated channel via an uttered channel selection command (direct command mode) or based on the application [102] whose window is being displayed on the desktop (passive command mode). Alternatively, the voicepad [101] may be configured to accept input at any time through any of the channels. Still other ways in which one or more channels may be collectively or selectively interfaced with a voicepad [101] may be achieved.

AVA Using Voicepad to Populate Later Screens

In one embodiment, AVA is in communication with one or more databases [103], and is configured to search those databases [103] upon receiving information about a caller or transaction. AVA may be configured to pre-populate its own fields (and those of other applications/forms/etc.) with such information from the database(s) [103]. For instance, if AVA learns that the caller is named John Smith, it may automatically search the database(s) [103] for entries relating to John Smith. Upon finding such an entry, AVA may pull information from the associated database entry and automatically populate the voicepad [101] and/or the corresponding fields with such information. AVA may thus include information known prior to the call, in addition to information gathered during the call. To the extent that AVA finds several database entries relating to several individuals and is unable to determine which of these individuals is the caller, AVA may wait until enough additional information is obtained before completing the association. AVA may also prompt the CSR to obtain confirmation to ensure that the association is accurate. Alternatively, AVA may present the CSR with a listing of possible individuals, and complete the association with a single individual in response to a selection made by the CSR. Still other ways exist in which AVA may associate and use information obtained during a call and information known prior to the call.

A system may also be configured to utilize dynamic navigation to create and/or invoke voice enabled short-cuts for the CSR. For example, software may be configured to recognize when the CSR says “help me.” When the AVA receives a “help me” message, the system may bring up a list of short-cut or transaction choices for the CSR that are context-sensitive. The CSR may then select a choice verbally or by other means.

Parallelism

AVA may also pull information from other applications [102] and populate its fields with such information (e.g., where an application [102] was opened prior to AVA being opened).

When a GUI application displays a screen of fields, buttons and/or drop-downs to an agent, they are perceived as simultaneously available so that any action using these means can be taken. Some actions may require prior actions (e.g., input of data), but the fact that all graphic input mechanisms are presented simultaneously gives them the appearance of occurring in parallel. AVA leverages this parallel structure (inherent in most GUIs), by voice-enabling these input mechanisms, and applies it across one or more screens and/or applications. Consider two screens, such as the home page and a service selection screen where two actions (one on each screen) are required to move the transaction forward. AVA enables both screens to be considered occurring simultaneously (in parallel) with each other so that one phrase (e.g., “service selection”) moves the agent through both screens at the same time. Finally, consider more than two screens. AVA permits all of them to be considered as a unit, and the data to be placed in any of them in any order as part of entering the required information. One utterance can provide all the data. AVA knows/tracks which fields are required to complete a transaction in a given context so as to efficiently move to the next screen. Words/data for filling in the GUI fields are stored in a voicepad until they are ready for acceptance by the underlying GUI. This means tasks may be started in any order since they are rendered as a set of conditions to be satisfied.

Tasks generally are composed of a number of subtasks and basic operations. Visual parallelism occurs when a GUI provides a screen of fields to be filled. Speech parallelism occurs when a number of pieces of information are spoken in an utterance. The nature of parallelism is that when all parts of the subtasks are perceived to be brought together in any order in a set slice of time, it is possible to execute (complete) the task in that set slice of time. The voicepad memory facilitates voice parallelism. It is the mechanism for storing the data for subtasks until the subtask is ready to execute. The “speak-ahead” capability of AVA enables the agent to speak data that is entered into a short-term memory buffer (e.g., the voicepad [101]), and then placed in the appropriate field of a screen when that screen is made available by commands supported by the GUI. Callers tend to volunteer service-related information prior to the time when the agent and/or GUI are ready to receive it. “Speak-ahead” removes the need for the agent to remember this data or write it down. It provides a mechanism that supports GUI/VUI-type parallelism (multiple choices at any step) and brings the VUI closer to the GUI. Decomposing parts of various UIs into units that can be compared, re-ordered and even auto-launched (completed) helps facilitate task-oriented parallelism.

Referring to component [104] in FIG. 1, the workflow model provides a structure for identifying those parallel events which trigger a transition to the next state. AVA facilitates workflow by providing default values and taking the next step(s) when possible. In this way, AVA brings parallelism into the workflow model. A service may be structured sequentially via a step-by-step procedure to enter data as imposed by GUI screens. A service may also be defined by reordering tasks, assuming default values for parallel data, and auto executing subtasks.

### SAMPLE EMBODIMENT ILLUSTRATING PARALLELISM

An agent may receive a request from a caller to “Delay Deliveries for 978-470-8406 until June 28^{th}”. This utterance may be given by an agent to provide data to a sequence of GUI screens, or spoken by a user of a touch-pad kiosk where a sequence of displays are presented. Individual parts can be stored in the voicepad memory when they are spoken, where they are kept for retrieval until they are needed for execution.

These two orderings of the data have the same effect:

Service Name, TN/CustID, Date

Service Name, Date, TN/CustID

AVA will use the data when the underlying application is ready for it.

Staging

Staging is a term used to indicate steps in the process, hence has elements of ordering or sequencing, and time intervals or duration. It addresses when actions are to take place, when a set of parallel conditions, discussed above, are sufficient to permit movement to the next step or steps. An action step may take place by instruction from the agent or from AVA. This illustrates that AVA processes actions through a mixed initiative model, meaning either the agent or AVA can execute steps. This builds on the overarching structure of doing tasks step-by-step, since AVA pays attention to the time when events occur. AVA supports two ways to execute a task: the agent signals the computer using the keyboard, mouse or voice at any time, or AVA may execute a step when a time out condition occurs or has collected sufficient information to perform the task. There are specific times when actions are ready to be taken, and certain inputs that are expected. AVA may be configured to know which steps are required along the way, and can indicate a step-by-step guide to focus an agent on the best predicted path.

AVA can change Time-Out (TO) intervals for subtasks depending on the caller, agent or system Reaction Time. The TOs reflect timing intervals for a task, and trigger the opportunity to lead the agent by predicting the next step in the transaction. AVA may be configured, through highlighted fields or other indicators, to indicate (for a time interval) which piece of information the system is currently expecting. Such highlighting (or other triggering) could be beneficial, for example, in prompting an agent for information to request from a caller. Thus, by using highlighting or other types of triggers, the system can proactively influence the agent's interaction with a caller, thereby increasing the efficiency and uniformity of customer interactions.

Execution of the commands can be performed in the same step-by-step sequence using the GUI or the VUI of AVA. Alternatively, however, AVA can also combine steps. For example, instead of clicking “Service Selection”, then clicking “New”, the agent may speak “New Service Selection”. Or, instead of typing a date using the format MMDDYYYY, the agent need only speak the month and day.

Streamlining

Streamlining can use a specially configured set of computer executable instructions [105] configured to accept a spoken keyword to start a service transaction (or partial service transaction). This starts a sequence of events based on assumptions that have a high confidence value. It follows the best path of call handling for each particular service type. Streamlining captures a complete task in a tightly scripted dialog. The agent initiates the specific service, through voice, which starts a sequence of shortcuts comprised of navigation steps and population of specific data fields with default values. AVA may pause at specific points to accept data that the agent requested, the caller provided, and the agent spoke into AVA. The streamlined transaction then moves to next task, until the service is completed. For example, “Hours and Location” starts the process and waits for entry of the ZIP to provide contact information about the vendor or retrieves ZIP information from voicepad to continue.

Streamlining begins with identifying the work flow used by the agent and caller to complete a service. The key steps of the spoken dialog that supports the work flow are determined, irrespective of the underlying GUI. The key steps are pre-determined and may be designed to be as minimal or as complete as desired. AVA then enables a command sequence that is triggered by speaking the service name, and expects only the minimal amount of critical-path information in order to complete the service. AVA assumes typical default values for all details while permitting changes to the details if the agent or caller volunteers the information. When the agent speaks, the data is accepted and AVA automatically attempts to move the transaction further. Streamlining lets the agent enter the data when it is provided by the caller rather than when a GUI field appears. AVA stores the data in a larger context (e.g., the voicepad [101]) until the target application presents the screen to accept it, and auto-launches any subsequent steps in the meantime. In streamlining, steps are not removed but are automatically executed if assumptions are found to be true.

The agent has the opportunity to validate results with the caller while back-end processing is being performed.

Some embodiments might also include instructions dedicated to performing exception handling [106], which could be invoked when a streamlining assumption is found to be false. In this case, additional data is entered through AVA, and a key word is spoken to bring the transaction back onto the streamline. Once the streamline is “broken”, the agent may revert to the GUI for exception handling to enter the immediate data, then re-enter the streamline using the appropriate trigger phrase. For instance, if the telephone number does not generate a successful DB retrieval (private listings, cell phones), the streamlined command sequence stops (e.g., the next command is not auto executed), and exception handling is performed using the GUI or VUI. The agent may enter the caller's name and address, typing it into the appropriate fields. Once the data is entered, the agent then says “submit the address” (or other key phrase) and the call is placed back into the streamlined flow/path.

AVA may be further programmed to include the ability to perceive intent of a user based on any of a variety of factors or inputs, including but not limited to vocal utterances, key combinations, mouse clicks, known data, actions, and combinations thereof. AVA associates a perceived intent with a navigation action to be taken and/or the implementation of such associated action.

AVA may thus leverage speech recognition of a CSR's utterance to determine where the CSR would need to navigate on a desktop to accomplish a business transaction. Another concept that may be leveraged may be referred to as state information. “State information” may comprise data about a specific customer in a given call. State information may further comprise a combination of the recognized CSR's speech and other call-related information, such as that gathered from the CSR or back end systems (e.g., applications [102], IVR, etc.). A voice pad [101] may store or otherwise store such state information. State information may then be pulled into a variety of applications [102], forms, etc. via AVA.

In one example, a CSR may repeat back to the customer that the CSR believes that the customer would like to change his or her service. AVA would recognize that the CSR needs to navigate to a particular application [102] that manages customers and services for a given business, and may further provide such navigation upon such recognition. This navigation could include the invocation (e.g., launch, initiation, enablement, etc.) of an application, or a change in focus to an application that is already running on the CSR desktop.

AVA provides an opportunity for the system to suggest (coach) likely actions to be taken by the agent. For instance, after a short initial period (e.g., 10-15 seconds) with primary focus on key words or fields, AVA then broadens the focus by highlighting (and perhaps blinking) the background of fields likely to be used to complete a transaction, for field names and navigation words in the active vocabulary.

AVA may be configured to perceive intent based on several words uttered within a certain proximity or context. This example is similar to the keywording with context sensitivity described above. Still other ways in which AVA may perceive intent will be apparent to those of ordinary skill in the art.

Further, a central data store (e.g., database 103) may provide a source of business intelligence because it may reflect the business operations that took place, regardless of the fact that the business transaction may have spanned several heterogeneous applications [102]. For instance, for a complex transaction such as a customer cell phone activation, many different applications might be accessed on the CSR desktop to accomplish the business transaction. The navigation actions of the CSR may be tracked and stored as part of the persisted session information. This business intelligence may enable improved analysis of the application to application navigation taken by CSRs in a given business transaction. The data may also provide a detailed, comprehensive view of a transaction that occurred across various applications [102] that may be used to further enhance AVA and/or improve the current application/transaction or to develop new applications.

In some embodiments, AVA may be configured to pull up only the customer applications [102] that are relevant to the customer's call based on the customer's communication and/or the CSR's communication. Further, AVA may populate fields in the various applications [102] as information is discovered during the course of the call, when it launches or navigates to such applications [102], or at any other time. AVA may also utilize default values. For example, forms necessary to complete a task may be automatically filled out (e.g., a purchase order) during the course of the call, after the call, in response to a command by the CSR, or in response to any other event or at any other time. Such recorded text may be searched for keywords to assist in analysis of trends, observance of rules, etc.

In addition, AVA allows the CSR to pre-record voice samples (e.g., samples of call openings or other standard phrases) that may be archived and recovered from a central server to allow CSRs to use spoken words to move from workstation to workstation. For example, script programs may be written as part of the CSR log-in or sign-on for each workstation. Accordingly, the files may be recovered when the CSR logs in or signs onto a workstation.

In another embodiment, AVA may be configured to navigate to or otherwise provide an internal pop-up that includes a list of shortcut links that may be physically (e.g., via keyboard or mouse, etc.) or verbally selected. Such shortcut links may lead to any suitable applications [102]. AVA may also select these links for presentation based upon data entered and/or prior user input.

Streamlining Guidelines and Standards

The following set of streamlining guidelines may be used in an embodiment of the invention.
1. Find a transaction or transaction part that requires considerable effort using the GUI to move from one state to another, where agent input of data is required. Identify if there are default values and navigation steps that AVA can perform instead of the agent. Have AVA perform the actions.
2. Have the agent's first command identify the issue or problem to be resolved, and begin execution of a streamline.
3. The system receives customer data asynchronously, as it is received and echoed by the agent. Speak-ahead is supported, and data placed in a buffer until the appropriate screen appears.
4. Automatically assume default settings to continually move the transaction forward, if they occur a predetermined percentage of the time (e.g., 66%).
5. When underlying assumptions fail, call handling may fall back to the GUI or VUI. This means that exception handling occurs to obtain specific data and then the transaction is inserted back into a streamline.
6. The agent dialog should use field names, although be colloquial so the agent can also use the terms for data verification with the caller.

### Streamlining Examples

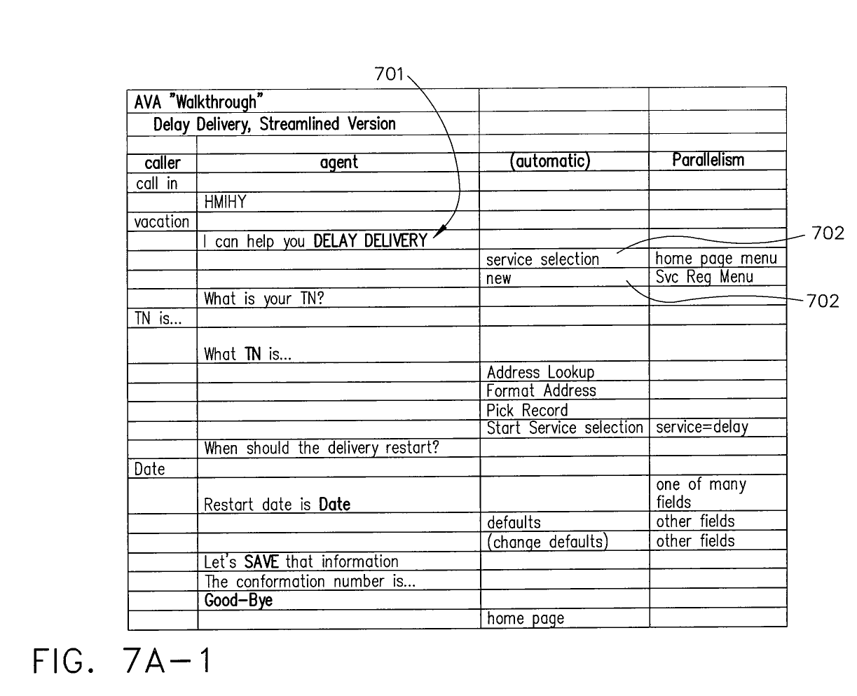

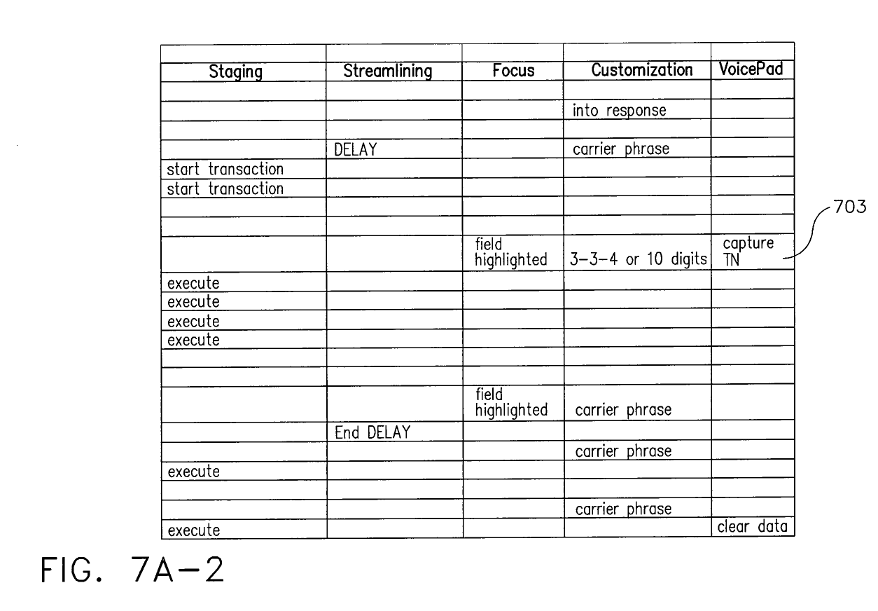

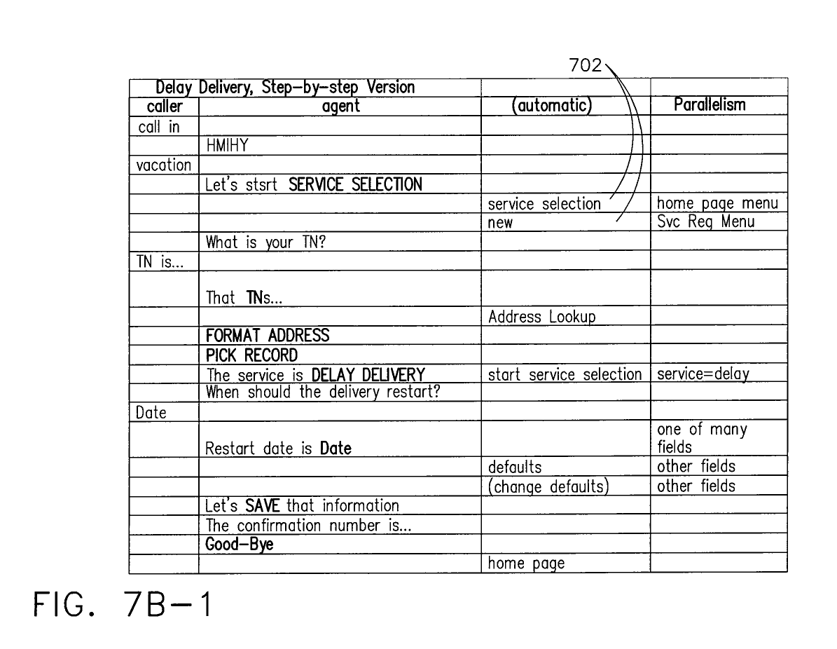

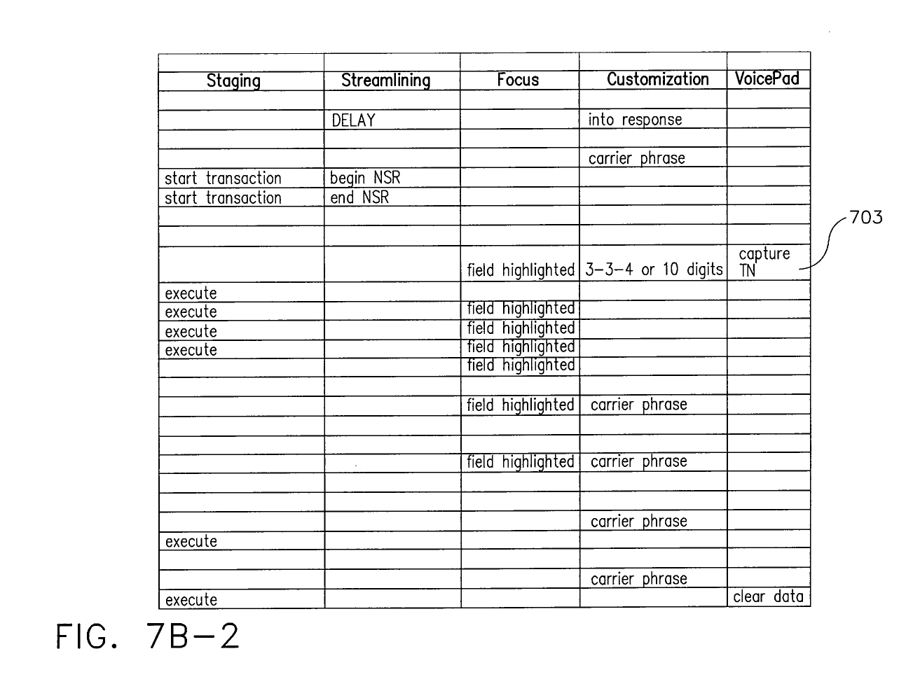

As an example, referring to FIGS. 7A-B (separated into FIGS. 7A-1, 7A-2, 7B-1 and 7B-2 for readability), an initial command [701] like “Delay Deliveries” leads to execution of “new service selection” [702], waits for the agent to speak the telephone number, then auto-launches the next series of tasks (which may themselves comprise subtasks). For the Delay Delivery transaction type, these tasks may include Address Lookup Request, Pick Record, and Start Service Selection for Delay Deliveries.

A call flow shortcut may be automatically launch a “new service selection” upon receiving the commands “Delay Deliveries”, “Redelivery”, “No Package received.” “New Service Selection” may also be individually accessed with a voice command.

Delay Deliveries

The agent is placed at the Service Selection screen, awaiting a Telephone Number. When this telephone number is given, the following sequence may be executed:
Telephone number is stored in Voicepad [703]
Address Lookup will be automatically launched;
if one address is available, screen will be updated with customer data
if multiple addresses are returned, pick record will be launched
<service type> will be placed in the service type field;
Start service selection will be automatically launched.

If conditions of the customer record do not enable automatic launch, the agent is left in a recoverable state where the standard responses of AVA can be used to carry on the transaction. An ASR error can be handled by speaking “cancel” or a similar word to back-up to the service selection screen or the last state where the transaction is known to be correct for re-entry of the TN.

The following is a sample dialogue, from the perspective of the agent, for a customer going on vacation:
How May I Help You?
I can help you to Delay Deliveries.
That number is 660 694 3592.
The delivery Date is June 28th.
I'll “save” this record.
Thank you and Goodbye.

An example of streamlining using the work flow model is described for the Delay Deliveries service. Once the agent determines that the caller wants their deliveries held, the agent says “Delay deliveries” [701]. AVA automatically launches an AVA “new service selection” command [702], arrives at the Service Selection screen and waits for a telephone number. This completes the first task. When the telephone number is entered, the service automatically performs an address lookup, expects the lookup to succeed, performs an address standardization which it expects to have one exact match, picks the exact match, enters the “delay deliveries” service type into the service type field and executes the “start service selection” command. This completes the second task. AVA is now positioned to accept the redelivery date—which may have been spoken earlier using the speak-ahead feature that stores the date in temporary memory (e.g., the voicepad) until the Delay deliveries screen appears. AVA then places the date in the field, enters other common default settings when a keyword is spoken, and executes a Save, to complete the third task.

Missing Package—Streamlined Transaction

Once the service selection is launched, the streamlined sequence may set the following default values:
Issue type set to Problem;
Issue Category set to Delivery or Pick-up;
Set Problem Category to Package Missing;
Details set to None of the above;
Call Back set to yes;

Track—Streamlined Transaction

Tracking numbers may be accepted in chunks using a predefined syntax. The interdigit timeout values, between the chunks, permit the agent to echo (validate) the number to the caller while entering it into AVA.

Focus

The first use of focus (highlighting, font change, blinking, etc.) is to change an indicator (e.g., the PTT button, see infra) to signify that AVA is ready for input. In some scenarios, AVA can be used to highlight those fields and navigation commands that are most frequently used and also voice enabled.

A speech recognizer can also use focus to indicate ASR performance and confidence in a word selection. A list of alternatives may be proposed in the control panel. If the agent takes no action after 10 seconds, AVA assumes the marginally confident word is correct and removes the focus from the entry.

Some embodiments might also include the ability to display an indicator of time spent on task compared to target time for the task. Similarly, other metrics (e.g., customer satisfaction, lack of deviations from a script, ability to effectively use streamlining and other interface features) could also be displayed and/or measured by a system using AVA technology. Further, an AVA system could be designed such that various rewards (e.g., recognition, enhanced evaluations, bonuses, and/or other inducements) would automatically be provided to an agent based on his or her observed performance. Of course, it should be understood that the description of measurement and rewards is not intended to indicate required features of the invention, and that the teachings of this disclosure could be implemented in a variety of manners both with and without the use of metrics and rewards.

Customization

An embodiment places a wrapper around an existing application rather than developing a GUI application developed from scratch. Of course the principles of this invention may be utilized in the development of a new application as well.

AVA permits a degree of customization to be obtained for each individual agent. The designers identify the grammar and vocabulary words for local and global contexts, but the agent may prefer other, more colloquial choices that may be selected and placed in an agent profile. It is possible that shortened phrases or semantically equivalent terms may also be defined by an agent for future use of the speech-enabled application.

The actual words spoken by the agent are derived from the dialog that follows a normal workflow. These words may follow caller terminology or standard terminology used on the GUI. The agent profile also contains information about the experience of the agent. This influences the time-out intervals and number chunking strategies in each task.

Push To Talk (PTT)

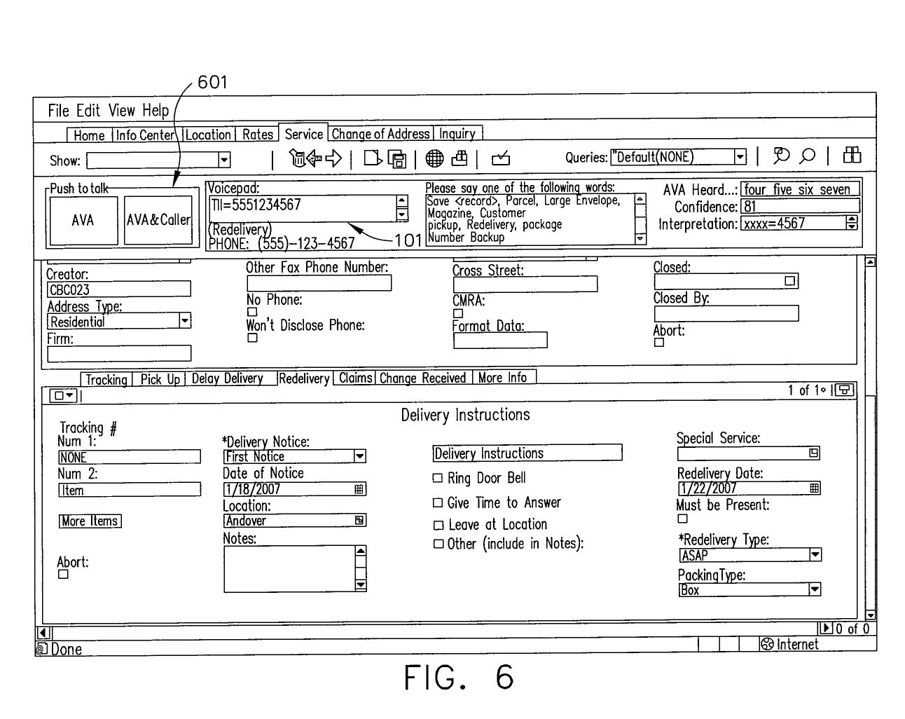

Turning now to FIG. 6, some embodiments might use a PTT button [601] to enable the user to transmit voice to the AVA system while depressing the button. Transmission stops when the PTT button [601] is released. This operation can enable the agent to clip snippets of the conversation with the caller and direct them to the recognizer in cases where an “open microphone” is undesirable.

AVA supports two PTT scenarios: mute and conference. The conferencing scenario may be supported through a media gateway via RTP stream forking (bridging). The alternate scenario to conferencing is muting. In the conferencing scenario, when the agent speaks, both caller and recognizer receive speech from the agent. In contrast, in the muting scenario, when the agent speaks, only the recognizer receives the voice data, i.e., the agent is muted to the caller.

The bridging capability for PTT, which allows caller participation, is useful when the agent repeats caller information for implicit verification by the caller, while speaking them into AVA. Numbers are often echoed back when the caller pauses between groups of numbers.

An area is defined of the GUI which includes the PTT buttons [601] for Mute, and Conference (Bridge), with two status “lights” for Record and Session Status. The Record function activates when the PTT is pressed and provides visual feedback to the agent that AVA is “listening.” In a preferred embodiment, this may be developed using the SandCherry Applet Code on Eclipse 3.1 with Java Version 1.5 or higher.

Screens

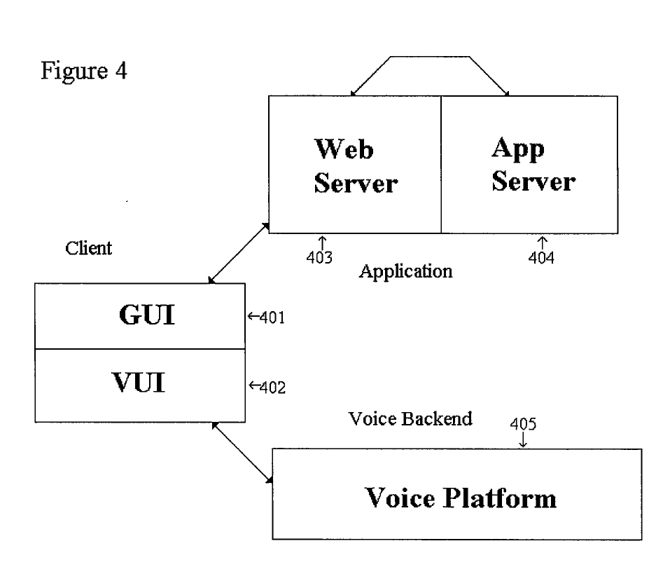

Referring to FIG. 4, the GUI and the VUI components of AVA can be integrated. The primary fields that require words provided from the vocabulary of the VUI are indicated graphically in the GUI.

Screens—Error Notification

Error notification, for low confidence recognition results, can be presented visually in two locations. For spoken input, AVA places the “best guess” (e.g., highest confidence ASR Choice) in the active field, highlights the answer, and positions the cursor at the start of that field. Additionally, a separate box/area may present an error correction mechanism. “Alternative Words” display likely choices, (e.g., the n-best alternatives obtained from the recognizer). There are four error correction methods:
The agent selects/clicks on the correct choice of the alternate word list with the mouse.
No input from the agent after a predetermined amount of time indicates acceptance of the proposed word even though it received a low confidence value.
The error may be corrected by speaking the word again.
The agent may also type the word into the field using the GUI.

When the recognizer encounters a “No Match” condition, meaning none of the possible choices exceed a confidence value, no text is placed in any field but an error message may be generated. If the recognizer encounters no input from the agent, the current PTT action is ignored.

User Feedback

Acknowledgement and verification of agent input may be provided at various places in the transaction as well as an indication that input has been accepted. Error detection and correction may be performed, and mechanisms to accommodate this may be presented to the agent.

Implementation

The target application may include navigation between numerous screens, entering caller data, performing database accesses, scrolling through screens, or ending the transaction. An embodiment may speech-enable the following actions to facilitate use of the target application (please note that virtually any task may be speech enabled and the following list is intended to be illustrative and not limiting):
(1) Click on a visible button;
(2) Move the cursor and place it in a field;
(3) Enter data in a selected field using the keyboard;
(4) Scroll (to expose hidden fields);
(5) Move the cursor to a pull-down icon and its associated menu;
(6) Move the cursor to selection an element in the menu; and/or
(7) Select a date from a calendar widget.

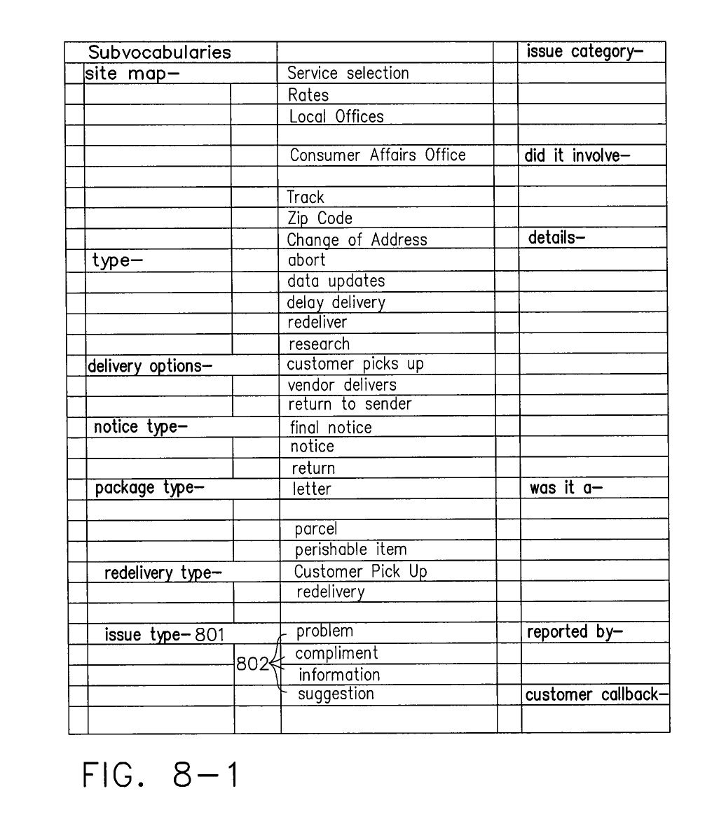

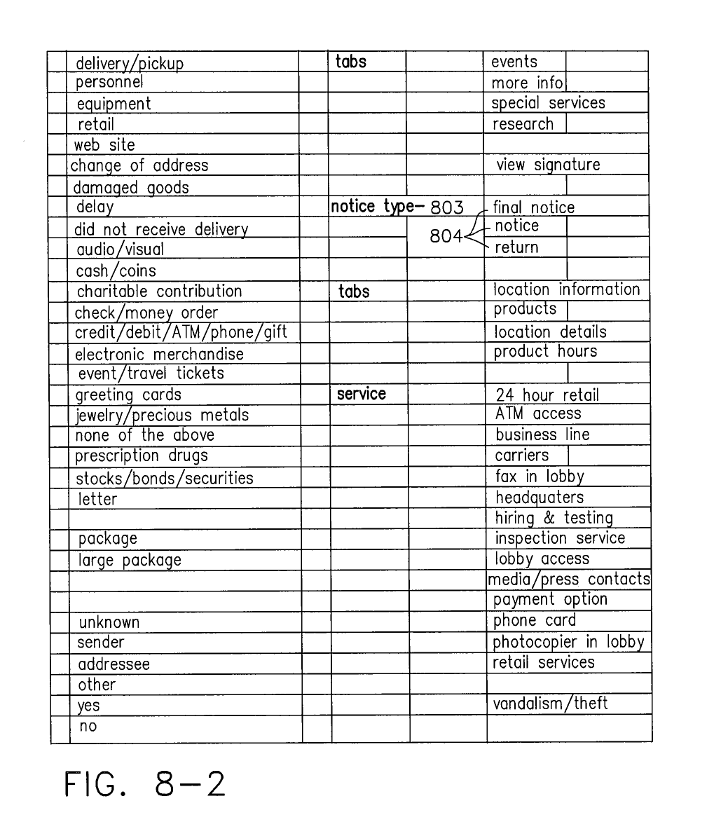

A small vocabulary ASR technology facilitates navigation generally performed with a Mouse and data entry normally performed with the Keyboard. Referring to FIGS. 8-1 and 8-2, specific vocabulary modules may be used for each navigation and data entry type required for completion of a subtask, and defined for particular steps in the transaction. For example, an issue type vocabulary module [801] might have entries [802] such as “problem”, “compliment”, “information”, or “suggestion.” Similarly, a notice type vocabulary module [803] might have entries [804] of “last notice”, “notice” and “return”.

In some scenarios, a core set of ASR functionalities may occur at some point in almost every service. The core set of functionalities will be dictated by the specific application being speech-enabled. For explanatory purposes, embodiments will be illustrated in the context of a delivery application. These capabilities are:
Telephone Number—10 digit continuous digit string
ZIP—5 digit string, with an occasional 4 digit extension
Calendar—month, day and year
Confirmation Number
Package Number—five letters, and 3 digits
Next—OK, Next, Previous (button to change state in a transaction)
Scroll—up, down (move window pane up or down)
Hidden (unlisted but active) options are also available—most notably: cancel, home page, and help.

Specific vocabularies may be used at particular steps of a typical transaction type. A command vocabulary and/or a data entry vocabulary is active at each step.

Simultaneous Vocabularies

While the agent generally executes a nominal ordering of steps during any transaction, the sequence of screens underscores the fact that there are numerous other options available for transitions to other windows or data entry into fields that are visible. AVA may provide capability by enabling a number of vocabularies to be simultaneously active. For instance, in an Inquiry about a package, the agent may be reading back a log of events describing package tracking, and the caller may spontaneously ask for More Information (a tab in the current screen) or location (information under the location tab from the home page). As another example, the agent may enter a telephone number or an address or a ZIP code in any order, thus, a preferred embodiment would have both of these vocabularies activated. Context increases the chance of correctly identifying the selection of the correct command from a number of active vocabularies.

Agents are also able to let caller speech activate AVA commands. Recognition of speech would preferably utilize large vocabulary, speaker independent ASR technology that is tuned to identify ethnic sound combinations (normally, specific consonant clusters) in order to improve spelling accuracy.

Number Entry

The entry of a string of numbers may be supported in a way that permits the agent to echo the number while it is spoken by the caller based on normal behavior of spoken digits, given that the agent generally prompts the caller to “say the telephone number, starting with the area code”. This results is the agent speaking the telephone number in groups of 3, 3, and 4 digits with the following syntax: 3 digits+T1+T2+T1+3 digits+T1+T2+T1+4 digits where T1 is the reaction time of the caller or agent to start the next digit chunk, and T2 is the time for the caller to say the next chunk. For example, T1 is about 500 ms, and T2 is about 2 secs, so the interdigit timeout time may be set to about 3-4 seconds.

### Example Walkthroughs

The following are some practical examples of how AVA might be applied to industry specific GUIs might. Please note that these examples are purely intended for illustrative, not limiting, purposes.

Shipping Industry

The Shipping may comprise a number of specific requests including, but not limited to, trace requests, package misdelivery inquiries, and delay delivery requests.

Trace Request

In this customer scenario, a customer, whose package has not been scanned in a while, requests an update. AVA streamlines this process by starting a case with the code phrase, “Recipient Delivery Issue”. Alternatively, late afternoon calls may automatically trigger this workflow, since most afternoon calls are inquiries about shipping status. This begins key stroke sequences and default settings which mitigates screens that require fields or drop downs. AVA also standardizes note processing with phrases for most common recipient dispositions (e.g., “recipient called in”, “no current scan” “please research”, “call back”).

Package Misdelivery

In this customer scenario, a customer receives a package in error and calls to have it picked up from their location. This scenario requires Case Creation, possible Site Creation (<10%), and Scheduling Pickup. AVA can mitigate case creation screens through drop downs and default settings. It can also standardize note processing with phrases for most common dispositions. Finally it can streamline the schedule pickup process, including folder navigation.

Delay Delivery

In this customer scenario, a recipient requests delivery for a package to be delayed until a given date. Early morning calls (6:30 am-7:30 am) automatically initiate this case. AVA navigates through case creation screens having multiple buttons and folders and facilitates case note processing. The streamlined navigation effected by AVA reduces the mouse clicks necessary to navigate from screen to screen.

Cable/Broadband

The cable/broadband industry may have a number of specific requests including, but not limited to, Customer Verification, Installation Request, Change of Service, Bill Explanation, Make Payment and Transfer of Service.

Customer Verification

In this scenario, a preliminary validation of customers is conducted at the time of contact, by verification of their name, address and the last 4 digits of their social security number. AVA streamlines this process by displaying the customer maintenance window and pulling profile information from a back-end database upon recognizing the code phrase, “Verify Customer”.

Installation Request

In this scenario, a customer calls in to install new service. This will require a work order, a billing change and an accompanying explanation. AVA will automatically navigate to the Install screen as well as streamline aspects of the credit check. AVA also provides standardized note-taking such as recipient called in”, “no current scan” “please research”, “call back”.

Change of Service

In this customer scenario, the customer calls in to add, delete a feature/service or modify their current subscription. This requires a work order, and likely a billing change that requires explanation. AVA streamlines navigation to order entry by auto-launching specific key stroke sequences by saying “Change Service”. It also streamlines steps to the Notes screen by closing one-time screen and navigating to Notes. AVA standardizes note processing with phrases for most common recipient dispositions such as “recipient called in”, “no current scan” “please research”, “call back”.

Bill Explanation

In this Customer Scenario, a customer calls in for an explanation about their bill, frequently a result of recent changes to their billing situation (e.g., bill above normal amount, Directory Assistance Charge, Disconnect and Reconnect, Promotional periods, etc.). AVA can mitigate bill review through invoking “Explain Bill”, then e.g. “Directory Assistance Charge”. AVA also standardizes note-taking processing with phrases for most common dispositions. Finally, it navigates automatically to ledger screen.

Make Payment

In this customer scenario, a customer calls in to make a payment using a credit card (e.g., want to pay bill in full; pay with previously used credit card, etc.). AVA mitigates navigation through invoking “Pay Master Card”, “Confirmation Number”, “and Customer ledger”. AVA also accelerates the data entry process (e.g., the amount of payment may be received verbally as opposed to typed in) and standardizes note taking (e.g., automatic time and date stamp, “paid in full”).

Transfer of Service

In this customer scenario, Customer from moves from first to second address, maintaining service subscription with the same carrier. This requires disconnect from the first address and new connection at the second address. AVA navigates automatically to the Transfer Service screen. AVA streamlines from end of Disconnect to beginning of Connect process.

Architecture

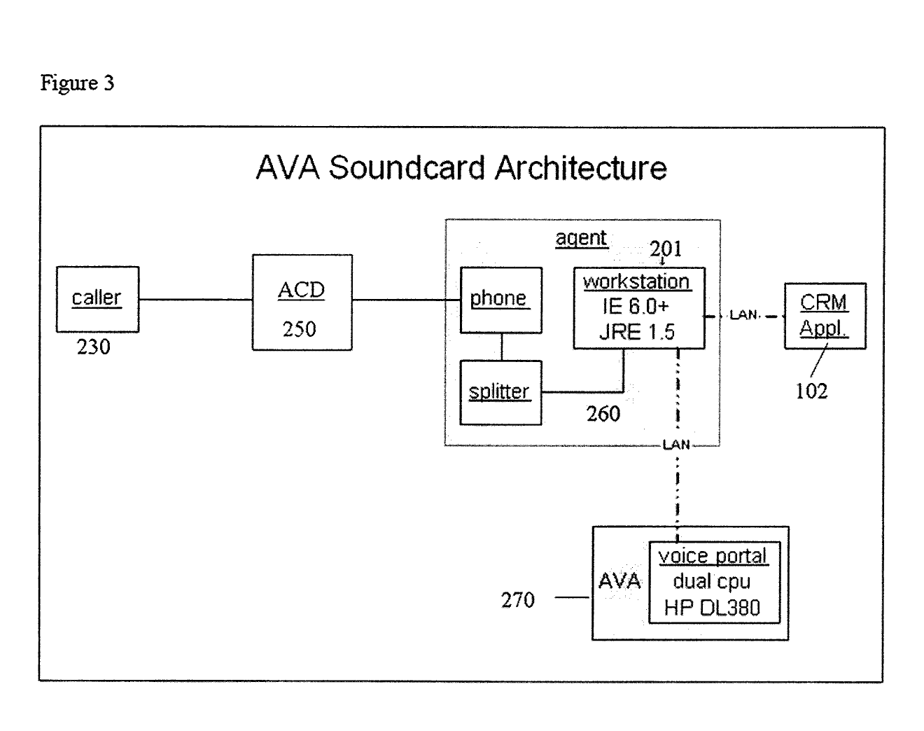

Referring to FIGS. 2 and 3, the AVA system is connected to the target system (e.g., can be connected either through the sound card on the agent desktop using a hardware splitter or connected to a SIP enabled media gateway (251)) between the ACD (250) and the agent (260). Calls are routed from the ACD (250) to a SIP-enabled media gateway (251). The gateway (251) forwards the call information via SIP (251) to the SIP server (252) in the AVA system (270). The SIP server (252) maps the requested address to an agent (260) phone (1-to-1 mapping) and directs the media gateway (251) to connect the caller (230) and agent (260). Because the SIP server (252) is a control point for the call, it can ask the SIP enabled media gateway (251) to also bridge in a recognizer when needed. When the agent (260) first connects to the application [102] a recognizer [210] is activated along with an RTP port to the SIP server [252]. When the agent [260] activates the push-to-talk (PTT) button [601] (not shown in FIGS. 2-3), the applet gives the RTP information to the SIP server [252] and it either bridges the recognizer [210] onto the call (conference), or it re-directs the agent voice to the recognizer [210] (mute)(2c).

In some cases, the architecture of the AVA system [270] can been implemented in such a way that it intrudes minimally upon an existing configuration of a GUI application host processor. To this end, there is both a physical and logical separation between the target and AVA backend systems. AVA interacts with target backend on behalf of the agent [260] through the agent's browser on the agent's workstation [201].

An embodiment of AVA uses a wrapper approach for integrating multimodality into the target application [102].

The AVA architecture reduces communication times for client-side validation and combination tasks. Several data validations which are generally performed at the server level can be performed by AVA at the client end, and then pushed directly to the target backend, saving validation and server roundtrip times. AVA pushes combined tasks to the target's backend in a single request, rather than performing one task at a time. In some cases, AVA might also talk directly to the target backend, rather than pushing data via the client end of the application. During certain tasks, this saves roundtrips to the target application server backend. In some cases, AVA can interact directly with the target and get data which it pushes to the Agent desktop directly at the client end, rather than have target application perform queries and requests to the target backend.

Target Integration

The AVA system [270] integrates with the target application [102] on the agent desktop [201] through its browser (e.g., Internet Explorer). AVA software on the agent desktop [201] can be contained within an applet and in Javascript that is downloaded with the initial target application [102] page when it is accessed. The desktop AVA software can control operation of the push-to-talk (PTT) button [601] activating/de-activating the recognizer [210], accepts the recognizer results, inserts results into the current page or navigates as appropriate, and displays status/error information to the agent [260]. The AVA desktop software synchronizes the recognizer state with the current page and fields of the target application [102].

Web Server, Application Server, and Voice Platform

Referring to FIG. 4, the agent [260] interacts with the GUI [401] VUI [402] client end of the AVA and target applications, and there are web [403] and application [404] servers for both the target and AVA. The voice backend comprises a voice platform [405] to process any input from the VUI [402].

The client end of AVA/target application combination comprises two components, namely:
1. Target client GUI [401]—This comprises the target front end application that the agent traditionally uses to perform various tasks and transactions.
2. AVA VUI [402]—This comprises the AVA front end that the agent uses to talk to AVA and to perform tasks traditionally performed on the GUI [401] front end.

At the backend, there are web servers [403] and application servers [404]. These include the target web server, AVA web server, and voice platform [405].

The Target Web Server refers to the backend web server; traditionally, this is where the target client content is served from. Requests to the target application server may be passed through the target web server. The AVA Web Server refers to the web-server that serves the AVA files. It includes AVA components in the form of HTML Pages for the AVA application, namely:
i. The page that launches the AVA application.
ii. The page that prompts the user for a login to SIP.
iii. The actual AVA application applet page, which launches the target client application, as a child window.

The Target Application Server comprises the target backend application server that processes the various requests that come in, performs database queries and interacts with (if any) the target applications' components within the system. The Target Application Server essentially comprises target scripts, business services and business components. AVA components in the form of the AVA Business Service have been added to enable the AVA components of the Target Web Server to communicate with the Target components of the Target Application Server. AVA can access these because of the HTML files which have been hosted on the Target Web Server.

Voice Platform

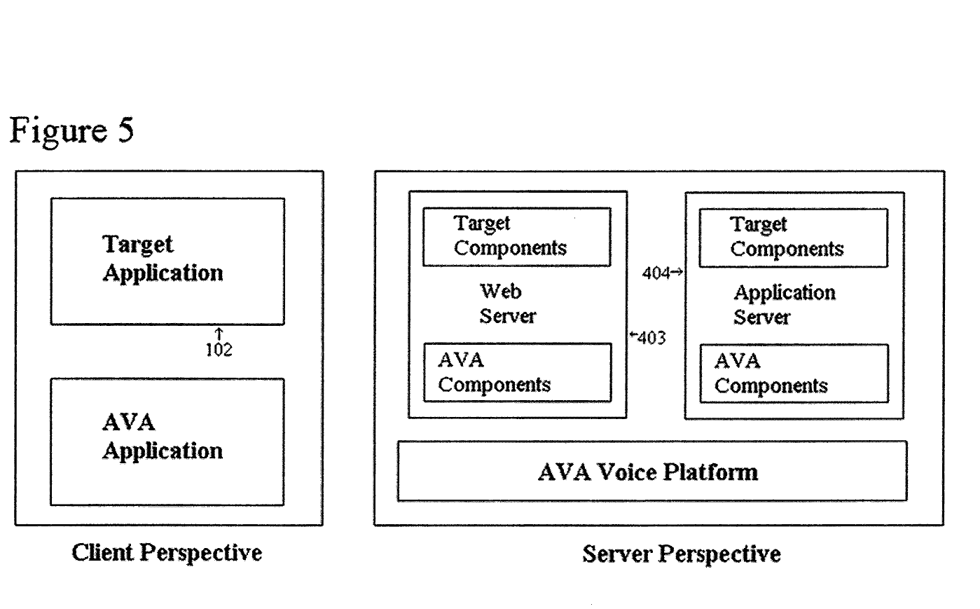

Voice platform refers to the system which receives the various incoming voice utterances from the AVA-client (e.g., an IVR). The voice platform applies appropriate grammar rules to these utterances and sends across the appropriate result to the AVA client application via the AVA Web Server. Referring to FIG. 5, various components are separated from the client and server perspectives. The figure also shows the target and AVA components that are hosted in the Target Web and Application Servers, and the AVA Voice Platform.

AVA Voice Platform refers to the combination of the IVR as well as the AVA server which contains the necessary logic for processing the voice requests. This comprises:
a. SIP (Session Initiation Protocol)—The IVR contains the SIP piece which directs the gateway to allow recognition on the call so that the utterance can be captured by the ASR.
b. ASR (Automated Speech Recognizer)—This piece includes the recognizer to help process the various utterance and return with recognition results.
c. VXML and GRXML—These define the valid utterance for each target page/view that the agent is on, and contain the voice and grammar definitions to help the ASR process the particular set of utterances for a given page/view.
d. JavaScript files—These define the logic and functionality behind the web-interface of AVA, which helps gather the recognition results and process them accordingly to perform the necessary tasks, by either communicating to the Target Servers or directly on the target client via DOM.

Client Side

Target Application [102] refers to the target client system used by the agent. This comprises the following:

a. A single, unique View, which is the web equivalent of a HTML page (henceforth referred to as a page for the purpose of convenience)

b. One or more ActiveX Applets, which are the web equivalents of HTML forms—Finding the necessary information of such controls on any given Target install is done via the Target Object Manager for that install. The Object Manager typically contains such information as the names and access control mechanisms of the ActiveX controls, which would be needed to access the controls.

c. One or more ActiveX Controls, which are the web equivalents of HTML fields (henceforth referred to as a field for the purpose of convenience)

One embodiment of an AVA client system comprises of the following pieces:
a. VIVO Applet—A Java applet, which that initiates and maintains a channel of communication between the agent, the SIP and the ASR
b. Status fields—Various status fields, which are a combination of HTML and JavaScript.
c. Target AVA Business Service access mechanisms—JavaScript callbacks to invoke the ABS on the Target backend.
d. Target Application DOM access mechanisms—JavaScript functions to perform various tasks on the target client via the DOM.

Component Flow

The initialization procedure for AVA is as follows:
1. Agent initiates the AVA/target system by pointing to the URL of the AVA home page on the Target Web Server
2. The AVA home page contains JavaScript code that generates content dynamically, and contains a pointer to the base functions on the AVA Web Server
3. Based on this code, login file is launched
4. The login page contains JavaScript code that generates content dynamically, and contains a pointer to the initial functions AVA Web Server
5. This pops up an agent SIP authentication screen
6. The agent supplies the login UID which is authenticated by SIP and passed down to the mmapplet.html file as a query string, on the Target Web Server
7. The mmapplet.html file contains JavaScript code generated from the global includes variable initializations.
8. All other dependent JavaScript files are loaded, and the AVA application is usable at this point

A sample scenario describing the flow of data during an AVA/target call after AVA has become usable is given below:
1. Agent is logged in, ready and waiting to receive the call
2. Agent receives the call from the caller
3. Target and AVA are active and ready
4. Agent speaks a phrase into the phone
5. The MMApplet Java applet within the mmapplet.html gets the phrase from the agent, and patches on the recognizer listening on the phone call
6. The mmapplet.html talks to the target voice-enabled client application and gets the appropriate details, such as the current view, current applet and the like
7. Based on this information, the JavaScript code gives pointers to the appropriate VXML and GRXML to the ASR
8. Based on the grammar involved, the ASR processes the result and the IVR passes this information back to the MMApplet Java applet
9. The JavaScript code gets this information from the MMApplet Java applet via a JavaScript callback in the form of an interpretation object
10. Based on the results contained within the object, the JavaScript code performs the necessary actions, in one of two ways:
   a. Access the target client via the DOM and perform the appropriate task
   b. Invoke the voice enabled application API to perform the appropriate task
Note: Choosing the appropriate method is done as a function of server-trips, access issues and technology limitations. For instance, all client-side operations are done via DOM to save time on Server Trips, while some tasks involving the voice enabled application cannot be performed without the voice enabled application API.
11. If the DOM was invoked, the changes are reflected directly on the target client the same way they would if the agent would have used the GUI
12. If the API was invoked, the Target application server performs the appropriate action, and this is reflected on the target client using the standard methods of the application.
13. Agent repeats steps 3-12 as many times as necessary.

Development Toolkit

Development tools for configuring/programming AVA to the specific needs of the subject application can often be useful. To that end, AVA provides an Eclipse-based development tool for creating VXML dialogues and JSP control scripts for integration with the target. The tool facilitates the writing of the control scripts in a way that separates control and presentation components (i.e., SCXML). The tools also allow the developer to cache data from one screen for use on another screen. This includes any Javascript or applet code running on the agent desktop. In some applications, portions of the application will be modified to provide the necessary integration points (initial start-up, DOM access, etc.).

Self-Care Interactions

As stated previously, the examples and explanations set forth above are provided for the purpose of illustration only, and are not intended to imply limitations on the potential implementations of the teachings of this application. As an example of additional implementations of the teachings of this application, consider that the AVA technology described above as facilitating interactions between an agent (e.g., a customer service representative) and various computer interfaces could also be used to facilitate self care by a customer. Thus, AVA technology could be used to transform a standard self-care application, or informational website into a voice enabled self-care application or website which the customer could more easily interact with, or to allow individual consumer devices, such as hand held devices like PDAs, to themselves be AVA enabled.

Of course, utilizing AVA to transform a conventional self-care application into an AVA enhanced self-care application with a multimodal user interface is not the only beneficial use of the disclosure set forth above in the context of self-care. For example, utilization of streamlining, such as described above, could also be beneficial for self-care interactions, as it could help alleviate the need for the customer to enter information into an application. Similarly, the provision of triggers in an interface, such as was described previously, could be beneficial in a self-care situation where such triggers could help the (potentially untrained) customer know what information should be provided at specific points in an interaction. Also, AVA technology could enhance self-care applications and interactions in other ways as well. As described previously, AVA technology can be used to integrate multiple applications by distributing information provided to one application to other applications which would also require that data. In the self-care context, that simultaneous data entry capability could be utilized to automatically generate forms which could be used to complete transactions desired by the customer. For example, if a customer wanted to cancel a service, an AVA enhanced self-care application could be used to automatically generate a service cancellation form for the customer, then route that form to the appropriate department for service cancellation. Of course, automatic form generation is not limited to being utilized in the self-care context. Thus, AVA could be used to increase efficiency in organizations where otherwise agents or customer service representatives would be expected to fill out and route forms themselves.

1. A system comprising:
a) one or more customer service applications, said one or more customer service applications operable to cause a plurality of windows to be presented on a display, said one or more customer service applications configured to receive input via a mechanical input device;
b) an operating system, said operating system configured to identify a window from said plurality of windows as active;
c) a multimodal support application, said multimodal support application configured to:
i) receive an auditory input stream and an identification of the active window from said plurality of windows;
ii) identify a context based on said identification of the active window from the plurality of windows;
iii) identify a keyword in said auditory input stream;
iv) associate said keyword and said context; and
v) based on said keyword and said context, issue one or more commands, said commands manipulating at least one of said one or more customer service applications.

2. The system of claim 1, wherein manipulating said at least one of said one or more customer service applications comprises launching a customer service application from said one or more customer service applications.

3. The system of claim 1, wherein said multimodal support application is resident on a workstation operated by a customer service representative.

4. The system of claim 1 wherein said one or more customer service applications comprise a self-care application.

5. The system of claim 1 wherein said multimodal support application is configured to manipulate said at least one of said one or more customer service applications by using one or more application programming interface functions exposed by said at least one of said one or more customer service applications.

6. The system of claim 1 wherein said system is deployed across a plurality of components, said plurality of components comprising a client computer, an application server, and a voice assist server, wherein:
a) said operating system is resident on said client computer;
b) said one or more customer service applications is resident on said application server;
c) an automatic speech recognizer is resident on said voice assist server; and
d) said multimodal support application is configured to use a local portion resident on said client computer to mediate communication of said auditory input stream to said voice assist server, and a remote portion resident on said voice assist server to identify the keyword in said auditory input stream.

7. The system of claim 6 wherein said remote portion of said multimodal support application is configured to communicate directly with said one or more customer service applications resident on said application server and wherein said client computer is a customer service representative workstation.

8. The system of claim 7 wherein said local portion of said multimodal support application is configured to mediate communication of said auditory input stream by performing actions comprising:
a) monitoring operation of a push to talk tool; and
b) transferring real time protocol information for said voice assist server to a session initiation protocol server.

9. The system of claim 1 wherein manipulating at least one of said one or more customer service applications comprises entering a data value in a non-active window from said plurality of windows.

10. A system comprising:
a) a customer service application, said customer service application configured to perform one or more tasks during a customer service interaction;
b) a graphic user interface, said graphic user interface comprising a plurality of windows, and operable to enable a user to provide a set of data necessary for completion of a task from said one or more tasks to said customer service application, wherein one window from said plurality of windows is an active window;
c) a plurality of grammars, each grammar from said plurality of grammars corresponding with one or more windows from said plurality of windows;
d) an automatic speech recognizer, said automatic speech recognizer configured to provide an interpretation for an auditory input using a set of active grammars from said plurality of grammars; and
e) a set of computer executable instructions stored on a computer readable medium and operable to configure a computer to perform a set of tasks, said set of tasks comprising:
i) allowing said user to provide the auditory input to said automatic speech recognizer;
ii) identifying said set of active grammars such that said set of active grammars comprises one or more grammars from said plurality of grammars which correspond to the active window; and
iii) based on one or more keywords identified by said automatic speech recognizer using said set of active grammars, providing a set of commands to said customer service application.

11. The system of claim 10, wherein:
a) each window from said plurality of windows comprises one or more fields;
b) for each of said fields, a grammar from said plurality of grammars is particularly configured to recognize input for that field; and,
c) the set of active grammars which corresponds to the active window comprises the one or more grammars particularly configured to recognize input for the one or more fields from the active window.

12. A system comprising:
a) one or more customer service applications configured to perform a task during a customer service interaction;
b) a voicepad, said voicepad configured to contextually store a plurality of inputs received during the course of said customer service interaction; and
c) a multimodal support application, said multimodal support application configured to perform a set of acts comprising:
i) transferring one or more inputs stored in said voicepad to said one or more customer service applications;
ii) sending one or more commands to said one or more customer service applications to complete the task once a set of inputs necessary for said task has been transferred to said one or more customer service applications;
wherein said one or more customer service applications is configured to receive input via a mechanical input device.

13. The system of claim 12 wherein said one or more customer service applications are operable to cause a plurality of windows to be presented on a display and wherein said multimodal support application is further configured to automatically insert an input stored in said voicepad into a first field in a first window from said plurality of windows and a second field from a second window from said plurality of windows.

14. The system of claim 13 wherein said first window is an application window for a first customer service application from said one or more customer service applications, and wherein said second window is an application window for a second customer service application from said one or more customer service applications.

15. The system of claim 13 wherein contextually storing said plurality of inputs comprises appending a tag to said automatically inserted input, wherein said first field and said second field are identified as being semantically equivalent using a software perceptible marker and wherein said software perceptible marker corresponds to said tag.

16. The system of claim 13, wherein causing said plurality of windows to be presented on said display comprises causing said plurality of windows to be presented on said display in a sequence, wherein said first window is presented on said display at a first time, and wherein said second window is presented on said display at a second time, and wherein said second time occurs after said first time.

17. The system of claim 12 wherein said multimodal support application is further configured to monitor whether the set of inputs stored in said voicepad is required by said one or more customer service applications to complete said task, and wherein transferring said set of inputs stored in said voicepad to said one or more customer service application is triggered by said one or more customer service applications requiring said set of inputs to complete said task.

18. The system of claim 12, wherein said multimodal support application is configured to send said one or more commands to said one or more customer service applications based at least in part on an assumption having a high confidence value.

19. The system of claim 18, wherein said assumption comprises a value for data transferred to said one or more customer service applications.

20. The system of claim 18 wherein said assumption comprises an identification of a sequence of events desired by a user of said one or more customer service applications.
